(19) United States
(12) Patent Application Publication
(10) Pub. No.: US 2013/0139725 A1
(43) Pub. Date: Jun. 6, 2013

(54) METHODS OF MANUFACTURING PLASTIC MATERIALS FROM DECOLORIZED BLOOD PROTEIN

(71) Applicant: Waikatolink Limited, Hamilton (NZ)

(72) Inventors: Casparus Johannes Reinhard VERBEEK, Hamilton (NZ); Mark Christopher LAY, Hamilton (NZ); Aaron Wai Kit LOW, Hamilton (NZ)

(73) Assignee: WAIKATOLINK LIMITED, Hamilton (NZ)

(21) Appl. No.: 13/691,438

(22) Filed: Nov. 30, 2012

Related U.S. Application Data
(60) Provisional application No. 61/566,520, filed on Dec. 2, 2011.

(51) Int. Cl. C08L 89/00

(52) U.S. Cl. CPC C08L 89/00
USPC 106/154.11; 106/124.1; 106/156.5; 106/156.2

(57) ABSTRACT

The present disclosure provides methods for manufacturing plastic materials from decolorized blood protein. The method includes the following steps: contacting the blood protein an oxidizing agent to form a blood protein composition that includes unreacted oxidizing agent; removing at least a portion of the unreacted oxidizing agent from the blood protein composition to form a decolorized blood protein composition; and treating the decolorized blood protein composition in the presence of a plasticizer with sufficient pressure and temperature to form the plastic material. The present disclosure also provides a plastic material including a blood protein residue having a percent whiteness of 35%-100% and a plasticizer.

### CROSS REFERENCE TO RELATED APPLICATIONS

This application claims the benefit under 35 U.S.C. 119(e) of U.S. Provisional Application No. 61/566,520, filed on Dec. 2, 2011, the disclosure of which is hereby incorporated by reference in its entirety.

### BACKGROUND

1. Field

The present disclosure relates generally to methods of manufacturing plastic materials, and more specifically to methods of manufacturing plastic materials from decolorized blood protein. The present disclosure also provides a plastic material including a blood protein residue having a percent whiteness of 35%-100% and a plasticizer.

2. Description of Related Art

Modern plastics are typically produced from petrochemical sources. Plastics are generally made up of polymers, including long chains of repeating molecular units, or monomers. The vast majority of plastics are composed of polymers of carbon alone, or carbon in combination with oxygen, nitrogen, chlorine or sulfur in the backbone. The properties of the polymer can be altered by introducing different functional groups into or onto the polymer backbone.

The history of plastic materials originated with the development of natural materials such as chewing gum and shellac. These materials however, require prohibitively expensive and intensive methods to isolate and manipulate the natural product. Later developments included the use of chemically modified natural materials such as rubber and nitrocellulose, and later to the use of manmade molecules such as epoxy, polyvinylchloride and polyethylene. The development of manmade plastic molecules has led to a staggering worldwide increase in the use of plastics, for wide ranging purposes, including packaging, technology such as computers, cell phones and many household appliances. Plastic is cheap and easy to manufacture.

The main characteristic of polymers that allows it to be so widely used is that some polymers can be thermoplastic (or plastic) and others can be thermosetting. Thermoplastic materials are deformable, they melt to a liquid when heated to a sufficient temperature and solidify into a solid state when cooled. Most thermoplastics are high molecular weight polymers whose chains associate through weak Van der Waals forces, for example in polyethylene, stronger dipole interactions and hydrogen bonding, for example in nylon, or stacking of aromatic rings, for example in polystyrene. Thermoplastic polymers differ from thermosetting polymers. Whereas thermoplastic polymers can be repeatedly melted and cooled, thermosetting polymers, once formed and cured will not re-melt to allow re-molding or re-use of the material. Thermoplastic or thermosetting polymers can be formed into a desired shape by injection into molds while in their liquid or fluid state and when cooled the shape of the mold is retained. In this way they can be easily be used to make a wide variety of complex shapes.

The manufacture of thermoplastics from petrochemical sources utilizes the following general method: 1) drilling and transporting petroleum to a refinery, 2) refining crude oil and natural gas into ethane, propane and other petrochemical products, 3) cracking ethane and propane into ethylene and propylene using high temperature furnaces, 4) the addition of a catalyst to ethylene or propylene in a reactor, resulting in a powdered polymer, 5) combining the powdered polymer with additives (if required) in a continuous blender, 6) feeding the polymer into an extruder where it is melted, 7) cooling the melted plastic which is then feed into a pulverizer that cuts the cooled plastic into small pellets, 8) shipping the pellets to customers, and 9) manufacturing plastic products from the pellets by various methods, including extrusion, injection molding, blow molding and rotational molding.

While the use of petrochemical sources to produce plastics is ongoing, it has a number of significant disadvantages, both to the environment and society. The first disadvantage is that plastics degrade very slowly. This leads to a high accumulation of unwanted and untreatable waste. While methods are being developed to increase the breakdown rate of plastics, such as the incorporation of biodegradable plastics or natural materials, such as starch is increasing, this in no way matches the worldwide consumption and subsequent disposal of plastic items. The high waste accumulation can also be off-set by recycling. However, recycling of plastics is not easy, and again includes a number of significant disadvantages. For example, it is difficult to automate the sorting of plastic wastes into plastic type or color, and the use of manual sorting is very labor intensive. An additional complicating factor is that while many plastic containers are made from a single type and color of plastic, which are relatively easy to sort, many other products such as cell phones often include many small parts of different types and colors of plastics. In these situations, the time and resources required to separate the plastics for recycling far exceed their recycling value.

A second significant disadvantage of standard plastic material is their effect on the environment. Plastics have a long breakdown time and can harm wildlife. For example, the plastic rings which hold 6-packs of cans can easily get around the necks birds and other wildlife and can strangle them. The increase of plastic waste in oceans may also lead to the transport of small species from country to country, or continent to continent. This may lead to the introduction of invasive or unwanted pests into new areas. Similarly, burning plastic material can in some cases release toxic fumes which can be harmful to those working or living in the area. Also, the manufacturing of plastics can often lead to large quantities of chemical pollutants.

A third significant disadvantage of petrochemical plastics is that petroleum resources are naturally limited. Therefore, in the future this is likely to lead to increased cost and decreased desirability of using these compounds on the current scale.

The problems with using petroleum based precursors in the manufacture of adhesives have been addressed by the development of a number of protein or soy protein based adhesives. Proteins are natural biopolymers. The amino acids found in proteins offer many chemical interactions, due to the different functional side chains. Hydrogen bonds, ionic interactions, hydrophobic interactions and covalent disulfide bonds between these side chains give a protein its native structure. Proteins are versatile materials; the properties depend on the amino acid content and the modifications that are performed to improve specific properties. Reactive amino acids in proteins include the following: amide (15-40%), acidic (2-10%), neutral (6-10%), basic (13-20%), and sulfur containing (0-3%) (De Graaf and Kolster, 1998).

In the materials industry these different side chains of proteins can be manipulated and used to add cross-linkers giving the material produced new mechanical properties. The processing of adhesives, films, coatings, or other protein based materials requires the breaking of intermolecular bonds (covalent and non-covalent), arranging the free protein chains into the desired shape, and then allowing the formation of new intermolecular bonds and interactions to stabilize the three dimensional structure. Cysteine, a sulfur containing amino acid, is found to be involved in non-disulfide irreversible covalent cross-linking (lysinoalanine and others) when proteins are placed under high temperature, which can become problematic in processing (Barone and Dangaran et al, 2006; Barone and Schmidt et al, 2006; De Graaf, 2000; Marion Pommet, 2003 and Singh, 1991). Lysinoalanine is an unnatural covalent crosslink that occurs through the formation of dehydroalanine and reactive lysl residues, in alkaline and heated systems. Cystine disulfide bonds form dehydroresidues in alkaline conditions, which are the reactive precursors for lysinoalanine. These non-disulfide covalent crosslinks once formed do not melt or exchange at high temperatures (Mohammed et al, 2000). Their formation in a high protein system can prevent a flowable melt material forming.

The major disadvantage of using protein based sources in the manufacture of adhesives is that they lack adhesive strength and water resistance. This issue has been addressed by using modified proteins such as soy, for example as described in WO 00/08110 which describes a method of using modified soy protein to provide a stronger and more water resistant adhesive. In the soy based adhesives described in WO 00/08110, the protein molecules are dispersed, and thus partially unfolded in dispersion. The unfolded molecules increase the contact area in adhesion of protein molecules onto other surfaces. The unfolded nature of the molecules also allows them to entangle each other during the curing process to provide additional bonding strength. Soy based adhesives overcome some of the problems associated with petroleum based products; they make use of soy proteins which are environmentally friendly and more sustainable than petroleum resources.

The soy proteins in WO 00/08110 are modified with one or more modifiers, including, for example urea, guanidine hydrochloride, SDS (Sodium Dodecyl Sulfate), and SDBS (Sodium Dodecylbenzene Sulfonate) or a mixture of these. The method disclosed involves mixing the modifiers, water and soy protein to form a slurry or dispersion. The modifiers act to unravel the proteins. After mixing, the reacted dispersion can be immediately used as an adhesive, or can be freeze dried, milled into a powder and stored for later use after being reconstituted. WO 00/08110 discloses reaction temperatures from 10 to 80° C. under which the mixing is carried out; however, preferably the mixing process is undertaken at ambient temperature and pressure conditions.

Bovine blood has previously been used as an adhesive. The main use of this was in the manufacture of particle board (Francis, 2000).

One disadvantage of using protein polymers which decreases their usability, is that they lack the mechanical properties of petrochemically derived polymers—this gives them unpredictable processing characteristics. A further significant disadvantage of protein polymers is the price. Protein polymers are significantly more expensive than commodity petro-chemically derived polymers. This increased cost has in the past been sufficient to prohibit mainstream use of protein polymers in adhesives.

The use of soy protein for the manufacture of plastic materials, given the high volume requirement for precursor material, places a strain on the supply source. This may decrease the amount of soy for food based products. Soy proteins also have the same disadvantages mentioned for protein polymers above, mainly the lack of mechanical properties and high price. Extrusion work on proteins has previously been undertaken for zein and soy proteins. These were plasticized with oleic acid, glycerol or water. Extensive research has also been undertaken on corn gluten meal (mixture of various proteins found in corn). It was found that various additives were necessary to plasticize these proteins, and that the material had inferior strength compared to petrochemical equivalents.

It would therefore be desirable to provide plastic materials, and methods of producing same from a high volume, low cost, sustainable and renewable protein source with sufficient mechanical properties. WO08/063,088 describes producing plastic materials from a protein source, including blood. However, improvements in the color and smell of blood-protein plastic materials are desirable if such plastics are to be used in a range of applications. Preferably, methods to decolor and/or deodor blood-protein plastic materials will maintain the molecular weight of the blood protein allowing it to maintain its ability to be processed into a plastic material.

Hemoglobin is a globular protein used to bind and transport oxygen in blood. Its molecular mass is approximately 64.45 kDa and contains two α and two β globin protein chains. Each a chain has 141 amino acids and each 0 chain has 146. All vertebrate hemoglobins are similar in structure and composition. Each globin chain has an iron containing heme group non-covalently bonded to it. The heme group is responsible for the color of the blood protein. To remove the color, the heme group must be removed or degraded.

Heme adsorption using organic solvents or adsorptive media has been used to produce decolorized hemoglobin. However, such reagents must be used in large quantities and are expensive, limiting their large scale application. Hemoglobin may be treated with proteolytic enzymes to produce peptides, but this method requires several processing steps. Hydrogen peroxide may be used as a less expensive alternative to decolor hemoglobin.

Heme is bound to the globin chain by non-covalent bonds. Treatment of hemoglobin at low pH (pH 2-5) causes the heme group to dissociate from the globin. Dissociated heme can be separated from the globin using organic solvents. Cold acidified acetone is the most efficient and most often used, but methylethyketone (MEK), methanol and ethanol have also been used. Tybor et al (1973) decolorized hemoglobin by adjusting to pH 4 using ascorbic acid prior to treatment with acidified acetone. This method required large volumes of acetone (4 liters of acetone per 1 liter of protein solution). This method has not been used on a large scale because acetone is toxic and it is difficult to remove residues from the final product. In addition, acetone is a volatile organic solvent; therefore, processing facilities need to be designed to contain it.

Adsorption media such as activated carbon or carboxymethyl cellulose (CMC) can be used as an alternative to organic solvents to remove the heme from acidified hemoglobin solutions. Sato et al (1981) used CMC chromatography to remove dissociated heme. However this method required low protein loading rates (1 g CMC to produce 70 mg globin). Tayot et al (1985) absorbed heme using activated carbon in the presence of alcohol, at pH 3 and below 20° C. Under these conditions activated carbon did not absorb globin and close to 100% protein was recovered. However, this method required a long residence time of up to 15 hours. Lee et al (1990) developed an alternative to CMC adsorption using sodium alginate to bind heme under various conditions. Optimized conditions (pH 2.25, 0.348% sodium chloride, and 0.107% sodium alginate) gave 64.9% protein yield.

Proteolytic enzymes have been used to degrade hemoglobin and release the heme. The released heme aggregates into micro droplets because of its hydrophobic nature. The amino acids and peptides from the hydrolyzed protein can then be separated from the heme by ultrafiltration or centrifugation. Pepsin, alcalase, and proteinase have been used to hydrolyze hemoglobin. The degree of hydrolysis will affect yield and properties of the peptides. Peptide yields reported in literature range from 65-85%. Strategies such as using exopeptidases for controlling the extent of reaction have been included to increase yield and reduce bitterness that can result from hydrolysis. The hydrolysates are not completely colorless and further treatment to remove heme using activated carbon, ultrafiltration, and/or bentonite clay is often required. Piot et al (1986) hydrolysed hemoglobin using pepsin at pH 2 for 3 hours. The peptides were then passed through alumina columns which absorbed heme containing peptides. When attempted on a large scale they had a protein yield of 25%. A white powder was obtained and consisted of peptide chains ranging from 5-13 amino acids long. Gomez-Juarez et al (1999) hydrolyzed hemoglobin using papain, a cysteine protease enzyme present in papaya, at pH 2.5 for 2 hours. The peptides were then ultrafiltered and decolorized using sodium hypochlorite at room temperature.

Hydrogen peroxide has been used to destroy heme. De Buyser (1999) and Izumi et al. (1991) suggest adding hydrogen peroxide to hemoglobin under alkaline conditions (pH 9-12.5). Wismer-Pederson and Frohlich (1992) suggest treating the hemoglobin at pH 2-2.5. Red blood cells are usually diluted to approximately 7% protein concentration. The amount of hydrogen peroxide used ranges from 0.3-10% (by protein solution weight). Residence times can reach 25 hours and temperatures range from 20-90° C. Care must be taken when treating hemoglobin with hydrogen peroxide because excessive hydrogen peroxide can result in the oxidation of sulfur-containing amino acids in the protein and also cause a decrease in functional properties. Other oxidizing agents that can be used include sodium peroxide, calcium peroxide, potassium peroxide, and nitrates.

Metabolism results in the production of hydrogen peroxide in vivo. Catalase is a natural defense mechanism against hydrogen peroxide. Catalase present in blood rapidly decomposes hydrogen peroxide into water and oxygen causing large amounts of foam and poor decolorization. Successful hydrogen peroxide treatment requires deactivation of catalase by heating to 70° C. or by mild acidic or alkaline treatment to denature the enzyme. When heat treatment deactivates the catalase, the hemoglobin coagulates and loses its solubility in water.

All of the decolorization methods described above have been developed for using decolorized red blood cells in human food. The methods would not be suitable for a bioplastics application because they are expensive, take long periods of time, and can hydrolyze the protein.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents. It will be clearly understood that, although a number of publications are referred to herein, this reference does not constitute an admission that any of these documents form part of the common general knowledge in the art, in New Zealand or in any other country.

It is an object of the present disclosure to address the foregoing problems or at least to provide the public with a useful choice.

Further aspects and advantages of the present disclosure will become apparent from the ensuing description which is given by way of example only.

### BRIEF SUMMARY

The present disclosure provides methods for the manufacturing of plastic materials from decolorized blood protein. In one embodiment, the method of decolorizing blood protein and manufacturing the decolorized blood protein into a plastic material comprises:
contacting the blood protein with an oxidizing agent to form a blood protein composition that includes unreacted oxidizing agent;
removing at least a portion of the oxidizing agent from the blood protein composition to form a decolorized blood protein composition; and
treating the decolorized blood protein composition in the presence of a plasticizer with sufficient pressure and temperature to form the plastic material. In some embodiments, the method further comprises contacting the decolorized blood protein composition with a denaturing agent prior to the treating step. In some embodiments, the blood protein is selected from the group consisting of whole blood, isolated red blood cells, serum, hemoglobin, blood meal, spray dried hemoglobin, and mixtures thereof. In some embodiments, the blood protein is blood meal or spray dried hemoglobin. In some embodiments, the blood protein is blood meal. In some embodiments, the oxidizing agent is selected from the group consisting of peracetic acid, hydrogen peroxide, sodium chlorite, and sodium hypochlorite. In some embodiments, the oxidizing agent is peracetic acid. In some embodiments, the peracetic acid is provided as an aqueous solution at a concentration of 1-5% peracetic acid by weight of the solution. In some embodiments, the peracetic acid is provided as an aqueous solution at a concentration of 3-5% peracetic acid by weight of the solution. In some embodiments, the denaturing agent is sodium dodecyl sulfate (SDS). In some embodiments, the denaturing agent further comprises one or more additives. In some embodiments, the one or more additives are selected from the group consisting of borax, sodium silicate, sodium bentonite, amine modified clay, and mixtures thereof. In some embodiments, the one or more additives are present at a concentration of 1-5 parts per hundred additive relative to the decolorized blood protein. In some embodiments, the plasticizer is selected from the group consisting of ethylene glycol, diethylene glycol, triethylene glycol (TEG), polyethylene glycol, glycerol, 1,2-propanediol, triacetin, triethyl citrate, tributyl citrate, epoxidized soybean oil, and mixtures thereof. In some embodiments, the plasticizer is selected from the group consisting of ethylene glycol, diethylene glycol, triethylene glycol, polyethylene glycol, 1,2-propanediol, glycerol, and mixtures thereof. In some embodiments, the plasticizer is triethylene glycol. In some embodiments, the plasticizer is present at a concentration of about 10-30% plasticizer by weight of the decolorized blood protein. In some embodiments, the plasticizer is present at a concentration of about 15-35% plasticizer by weight of the decolorized blood protein. In some embodiments, the treating is conducted in the presence of water at a concentration of 10-50% water by weight of the decolorized blood protein. In some embodiments, the treating is conducted at a temperature of 80-130° C. In some embodiments, the treatment is conducted at a pressure of 1.5-2.9 MPa. In some embodiments, the blood protein is blood meal, the denaturing agent is sodium dodecyl sulfate (SDS), and the plasticizer is triethylene glycol. In some embodiments, the decolorized blood protein composition has a percent whiteness of 35-100%. In some embodiments, the decolorized blood protein composition has a percent whiteness of 50-100%. In some embodiments, the decolorized blood protein composition has a percent whiteness of 60-100%. In some embodiments, the plastic material has a tensile strength of 1.5-6 MPa. In some embodiments, the plastic material has a stress at break of 0.25-1.5 mPa. In some embodiments, the plastic material has an elongation at break of 15-40 mm. In some embodiments, the oxidizing agent is hydrogen peroxide. In some embodiments, the hydrogen peroxide is provided as an aqueous solution at a concentration of 5-40% hydrogen peroxide by weight of the solution. In some embodiments, the oxidizing agent is sodium chlorite. In some embodiments, the sodium chlorite is provided as an aqueous solution at a concentration of 1-10% sodium chlorite by weight of the solution. In some embodiments, the oxidizing agent is sodium hypochlorite. In some embodiments, the sodium hypochlorite is provided as an aqueous solution at a concentration of 5-15% sodium hypochlorite by weight of the solution.

In further embodiments of the present disclosure, the blood protein is spray dried hemoglobin. In some embodiments, the oxidizing agent is selected from the group consisting of peracetic acid, hydrogen peroxide, sodium chlorite, and sodium hypochlorite. In some embodiments, the oxidizing agent is peracetic acid. In some embodiments, the peracetic acid is provided as an aqueous solution at a concentration of 2.5-3.5% peracetic acid by weight of the solution. In some embodiments, the peracetic acid is provided as an aqueous solution at a concentration of 2.5-3.5% peracetic acid by weight of the solution. In some embodiments, a ratio of the aqueous solution of peracetic acid to spray dried hemoglobin is 2.5-3.5:1 by weight. In some embodiments, a ratio of the aqueous solution of peracetic acid to spray dried hemoglobin is 3:1 by weight. In some embodiments, the denaturing agent is sodium dodecyl sulfate (SDS). In some embodiments, the denaturing agent is a mixture of sodium dodecyl sulfate (SDS) and sodium sulfite (SS). In some embodiments, the plasticizer is selected from the group consisting of diethylene glycol, triethylene glycol, polyethylene glycol, glycerol, 1,2-propanediol, triacetin, triethyl citrate, tributyl citrate, epoxidized soybean oil, and mixtures thereof. In some embodiments, the plasticizer is selected from the group consisting of ethylene glycol, diethylene glycol, triethylene glycol, 1,2-propanediol, glycerol, and mixtures thereof. In some embodiments, the plasticizer is ethylene glycol or glycerol. In some embodiments, the plasticizer is 1,2-propanediol. In some embodiments, the plasticizer is triethylene glycol. In some embodiments, the plasticizer is present at a concentration of about 15-35% plasticizer by weight of the decolorized blood protein. In some embodiments, the treatment is conducted in the presence of water at a concentration of 10-50% water by weight of the decolorized blood protein. In some embodiments, the treatment is conducted at a temperature of 80-130° C. In some embodiments, the treatment is conducted at a pressure of 1.5-2.9 MPa. In some embodiments, the blood protein is spray dried hemoglobin, the denaturing agent is a mixture of sodium sulfite and sodium dodecyl sulfate, and the plasticizer is ethylene glycol or glycerol. In some embodiments, the blood protein is spray dried hemoglobin, the denaturing agent is sodium dodecyl sulfate, and the plasticizer is ethylene glycol or glycerol. In some embodiments, the decolorized blood protein composition has a percent whiteness of 35-100%. In some embodiments, the decolorized blood protein composition has a percent whiteness of 50-100%. In some embodiments, the decolorized blood protein composition has a percent whiteness of 60-100%. In some embodiments, the plastic material has a tensile strength of 1.5-6 MPa. In some embodiments, the plastic material has a stress at break of 0.25-1.5 mPa. In some embodiments, the plastic material has an elongation at break of 15-40 mm. In some embodiments, the oxidizing agent is hydrogen peroxide. In some embodiments, the hydrogen peroxide is provided as an aqueous solution at a concentration of 5-40% hydrogen peroxide by weight of the solution. In some embodiments, the oxidizing agent is sodium chlorite. In some embodiments, the sodium chlorite is provided as an aqueous solution at a concentration of 1-10% sodium chlorite by weight of the solution. In some embodiments, the oxidizing agent is sodium hypochlorite. In some embodiments, the sodium hypochlorite is provided as an aqueous solution at a concentration of 5-15% sodium hypochlorite by weight of the solution.

The present disclosure also provides a plastic material, comprising: (a) a blood protein residue having a percent whiteness of 35%-100%; and (b) a plasticizer. In some embodiments, the percent whiteness is 50%-100%. In some embodiments, the percent whiteness is 60%-100%. In some embodiments, the plastic material further comprises a denaturing agent. In some embodiments, the denaturing agent is sodium dodecyl sulfate (SDS), sodium sulfite (SS), or a mixture thereof. In some embodiments, the denaturing agent is sodium dodecyl sulfate (SDS). In some embodiments, the plasticizer is selected from the group consisting of diethylene glycol, triethylene glycol, polyethylene glycol, glycerol, 1,2-propanediol, triacetin, triethyl citrate, tributyl citrate, epoxidized soybean oil, and mixtures thereof. In some embodiments, the plasticizer is selected from the group consisting of ethylene glycol, diethylene glycol, triethylene glycol, 1,2-propanediol, glycerol, and mixtures thereof. In some embodiments, the plasticizer is ethylene glycol or glycerol. In some embodiments, the plasticizer is 1,2-propanediol. In some embodiments, the plasticizer is triethylene glycol. In some embodiments, the blood protein residue comprises a blood protein and an oxidizing agent. In some embodiments, the oxidizing agent is selected from the group consisting of peracetic acid, hydrogen peroxide, sodium chlorite, sodium hypochlorite, and combinations thereof. In some embodiments, the oxidizing agent is peracetic acid. In some embodiments, the oxidizing agent is hydrogen peroxide. In some embodiments, the oxidizing agent is sodium chlorite. In some embodiments, the oxidizing agent is sodium hypochlorite.

### DESCRIPTION OF THE FIGURES

FIG. 1 depicts the blood meal molecular weight after being treated with different peracetic acid concentrations.

FIG. 2 depicts the red blood cell molecular weight after being treated with peracetic acid and other chemicals.

FIG. 3 depicts the modified red blood cell molecular weight after being treated with different chemicals.

FIG. 4 depicts the x-ray diffraction (XRD) analysis of peracetic acid treated blood meal.

FIG. 5 depicts the Young's modulus for 1-5% (w/w) peracetic acid treated blood meal.

FIG. 6 depicts the ultimate tensile strength for 1-5% (w/w) peracetic acid treated blood meal.

FIG. 7 depicts the stress at break for 1-5% (w/w) peracetic acid treated blood meal.

FIG. 8 depicts the elongation at break for 1-5% (w/w) peracetic acid treated blood meal.

FIG. 9 depicts the percent whiteness for 1-5% peracetic acid treated blood meal compression molded sheets.

FIG. 10 depicts the ultimate tensile strength for 4% peracetic acid treated blood meal with different additive concentrations.

FIG. 11 depicts the Young's modulus for 4% peracetic acid treated blood meal with different additive concentrations.

FIG. 12 depicts the stress at break for 4% peracetic acid treated blood meal with different additive concentrations.

FIG. 13 depicts the elongation at break for 4% peracetic acid treated blood meal with different additive concentrations.

FIG. 14 depicts the percent whiteness for 4% peracetic acid treated blood meal with different additive concentrations.

FIG. 15 depicts the x-ray diffraction pattern for 4% peracetic acid treated blood meal with different concentrations of sodium bentonite.

FIG. 16 depicts the x-ray diffraction pattern for 4% peracetic acid treated blood meal with different concentrations of amine modified clay.

FIG. 17 depicts the x-ray diffraction pattern for 4% peracetic acid treated blood meal with different concentrations of borax.

FIG. 18 depicts the x-ray diffraction pattern for 4% peracetic acid treated blood meal with different concentrations of sodium silicate.

FIG. 19 depicts extrusion and injection molding trials of decolorized blood meal.

FIG. 20 depicts extrusion of decolored spray dried hemoglobin (SDH) with sodium dodecyl sulfate (SDS) and sodium sulfite (SS) as denaturing agents.

FIGS. 21(A) and 21(B) depict extrusion of decolored spray dried hemoglobin (SDH) with sodium sulfite (SS) as the denaturing agent.

FIG. 22 depicts compression molds of decolored spray dried hemoglobin. (A) Formulation 11 with water (15 ppH), sodium dodecyl sulfate (3 ppH), and 1,2 propanediol (30 ppH). (B) Formulation 12 with water (25 ppH), sodium dodecyl sulfate (3 ppH), and 1,2 propanediol (30 ppH).

FIG. 23 depicts injection molded samples of Formulation 12 (see, FIG. 21(B)) with water (25 ppH), sodium dodecyl sulfate (3 ppH), and 1,2 propanediol (30 ppH).

FIG. 24 depicts extrusion and injection molded samples of decolored blood meal without use of a denaturing agent.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

### 1. Definitions

As used herein, the term “plastic material”, “plastic materials”, “plastics material”, or “plastics materials” means any substance that is able to be molded or formed into a desired shape or configuration. Preferably, the plastic material may have thermoplastic properties.

As used herein, the term “thermoplastic-like” or “thermoplastic” means that the plastic material will soften and flow on the application of heat.

As used herein, the term “thermosetting-like” or “thermosetting” means that the plastic material will not soften and flow on the application of heat. One skilled in the art would realize the cross-links between adjacent proteins, or portions thereof, would need to be broken in order for the plastic material to have thermoplastic properties.

As used herein, the term “blood meal,” means dried animal blood, usually bovine, containing approximately 80% proteins, with hemoglobin accounting for 75% of the protein content and plasma proteins the other 25%. The plasma proteins mainly consist of water soluble albumin (60%), and salt soluble globulins (35%), and fibrinogen (4%). Blood meal has high lysine content, and a high cysteine content of 1.4%.

As used herein, the term “blood protein residue,” means the residue that remains after blood meal or any component of blood meal is treated with an oxidizing agent. The oxidizing agents, may include, for example, peracetic acid, hydrogen peroxide, sodium chlorite, or sodium hypochlorite. The blood protein residue may contain unreacted oxidizing agent.

As used herein, the term “high number of cross-links” means sufficient cross-links to form at least a thermoplastic product, and if higher, a thermosetting product.

As used herein, the term “interactions between proteins” means any protein-protein interaction which contributes to protein bonding or structure. Interactions may include, but are not limited to disulphide bonds, hydrogen bonding, electrostatic interactions, Van der Waal forces, ionic interactions and hydrophobic interactions.

As used herein, the term “denature” means that the protein has a loss of structural order of at least some of the protein's secondary, tertiary or quaternary structure. This may include the breaking of cross-linking or interactions, such as disulphide bonds, electrostatic forces, hydrogen bonding and other protein interactions such as Van der Waal forces, or any other protein-protein interactions between different portions of a protein structure or adjacent proteins.

As used herein, the term “consolidate” means the decolorized protein solution becoming solid or firm in the form of a plastics material.

As used herein, the term “comprise” shall have an inclusive meaning—i.e. that it will be taken to mean an inclusion of not only the listed components it directly references, but also other non-specified components or elements. This rationale will also be used when the term “comprised” or “comprising” is used in relation to one or more steps in a method or process.

As used herein, the terms “decolorized” or “decolored” mean reduced in color relative to the starting material prior to treatment with the decolorizing agent. The terms do not mean 100% without any color.

### 2. Description

The present disclosure provides methods for the manufacturing of plastic materials from a protein source, such as blood protein. The present disclosure also provides methods for the manufacturing of plastic materials from decolorized blood protein. The present disclosure also provides a plastic material including a blood protein residue having a percent whiteness of 35%-100% and a plasticizer.

Plastic Materials Manufactured from a Protein Source Such as Blood Protein

According to one aspect of the present disclosure there is provided a method of manufacturing a plastic material from a protein source, the method characterized by the following steps;
i) treating the protein source with at least one denaturing agent to break interactions between proteins or portions thereof, and
ii) treating the denatured protein source with sufficient pressure and temperature to consolidate the denatured protein source into a plastic material.

In a preferred embodiment the method of manufacturing a plastic material from a protein source, includes the additional step of:
iii) treating or adding to the denatured protein at least one additive or agent to control or prevent further cross-links forming.

Preferably the plastics material may have thermoplastic properties. In a preferred embodiment the plastics material may be stable under normal use, and malleable under the correct temperature and/or pressure conditions. Alternatively the plastics material may have thermosetting properties, and not be able to be re-plasticized once formed and cured into a shape.

In a preferred embodiment the protein source may be animal derived. For example, waste protein from meat processing could be used as this is a plentiful and low cost source of protein. However, this should not be seen as limiting, as in some cases plant based material may be utilized with the present disclosure, such as soy.

In a preferred embodiment the protein source may be blood, and shall be referred to as such herein. In a preferred embodiment the protein source may be whole blood. However, this should not be seen as limiting as any protein containing fraction of blood may be utilized. Protein containing fractions of blood may include isolated red blood cells, serum, or other isolated fractions from whole blood.

However the use of blood as the protein source should not be seen as limiting. A variety of other animal derived proteins may also be utilized with the present disclosure, for example casein, or feather meal. Whole blood is a preferred raw protein source of the present disclosure as it is a high volume waste product of abattoirs.

In New Zealand alone, 80000 tons of blood is collected annually as a by-product of the meat industry. This is either disposed of or sold as low cost animal food or as fertilizer. Proteins account for approximately 16-18% of raw blood, with 80% water content. In one particularly preferred embodiment, the protein source utilized in the method of the present disclosure is blood meal.

In most countries around the world blood from animal slaughter and meat processing has to be collected and undergo suitable treatment prior to disposal. Given the high number of animals being slaughtered daily to meet meat demands the volume of blood which has to be disposed is considerable. Having to treat and dispose of blood as a waste product increases the cost, labor, time and equipment required for animal and meat processing. The high volume of blood which has to be disposed of provides a continuously available, high volume, low cost, renewable and sustainable protein source.

In one preferred embodiment, the blood may be bovine blood, and shall be referred to as such herein. Alternatively, the blood may be from other animal species such as pigs, sheep, goats, horses or any other animal which has a high slaughter or meat processing rate. In a preferred embodiment, the blood may be from an animal which leads to the highest volume of blood for disposal in the geographical area of use.

The total volume of blood produced in an abattoir or meat processing plant is calculated from the number of animals slaughtered multiplied by the volume of blood per animal. For example, in New Zealand, and many other western countries, cattle are one of the most common meat species. Cattle have a high volume of blood per animal, and a high number of cattle being slaughtered and processed daily. Alternatively in countries such as New Zealand which have a high sheep number and processing rates, blood from sheep may be utilized with the present disclosure.

However, in other areas of the world, where cattle (or sheep) may not be the main meat species, or result in the highest volume of waste blood, other animal blood may be preferred for use with the present disclosure. Examples of other animal species which may be utilized include pigs, chickens, camels, goats or horses.

In an alternative embodiment, the blood may be from a combination of two or more animal species. For example, this may be the case when a combination of animal species is being processed in a particular abattoir, or number of same.

According to another aspect of the present disclosure there is provided a thermoplastic material, including:

a protein source, and

at least one denaturing agent,

characterized in that the protein source is blood, or a fraction thereof.

In a preferred embodiment, the thermoplastic material may also include at least one additive or agent to control or prevent cross links forming. In a preferred embodiment, the raw protein source may undergo at least one treatment step in order to form the protein source utilized in the method of the present disclosure.

In one preferred embodiment, the raw protein source may be dried or concentrated to form the protein source utilized in the present disclosure.

In a preferred embodiment, the protein source may have high protein content. In one preferred embodiment, the protein source may have a protein content of at least 50%. In a particularly preferred embodiment, the protein source may have a protein content of at least 70%, and even more preferably a protein content of between 80 and 90%.

In an alternative embodiment, the protein source may have a protein source up to approximately 90% protein. It should be noted that the protein content will depend on the collection and processing of the protein source prior to use with the present disclosure.

It will be appreciated that the protein contents provided above relate to the protein source as utilized in the method of the present disclosure. One skilled in the art would realize that this could either be the raw protein source (if the protein content of this is sufficient), or treated raw protein source, which has for example been dried or concentrated.

In the case where the protein source is blood, or a blood derived fraction then the protein source will preferably be dried blood/blood fraction or blood/blood fraction meal. In a preferred embodiment, the protein source may be dried whole blood; this consists of almost 90% protein.

It will be appreciated by one skilled in the art that whole blood as collected from an animal or abattoir has a protein content of approximately 16%. When this is dried the protein content is increased to approximately 80 to 90%, by removal of water which makes up the balance of the whole blood as collected.

As another example, corn gluten meal contains approximately 70% protein, again this could be considered to be a high protein content.

In a preferred embodiment, the protein source may be predisposed to form a sufficiently high number of cross-links or interactions to adjacent proteins, or other portions within the same protein to form a strong, yet thermoplastic-like material.

Applicants have shown indirectly that by limiting or decreasing the number of cross-links which form in the product the properties of the product can be controlled, resulting in a product with either thermoplastic-like or thermosetting-like properties.

It will be appreciated by those skilled in the art that animal derived proteins, especially those in blood have very high protein content, and are predisposed to forming a high number of cross-links when heated. For this reason, animal derived proteins have previously been very difficult to process.

It is well known to those skilled in the art, and in current literature that blood and blood derived proteins are difficult to process. Previous work undertaken with blood proteins, wherein experimentation looking at extrusion of blood proteins under high temperature conditions of 180° C. was undertaken, came to the conclusion that these proteins are not able to be thermoplastically processed (Areas, 1992)

One significant advantage of the product and process of the present disclosure is that it allows a thermoplastic-like product which will soften, flow and be re-moldable to be produced from a protein source, such as blood proteins. The present disclosure allows a malleable and extrudable material which is able to be reformed and therefore easily recycled to be produced from a high volume, low cost protein source such as blood. This is something which has not previously been achieved with blood proteins, and provides a significant advance in the field of producing natural plastics materials.

The applicants anticipate that other animal derived proteins, such as casein could also be used with the present disclosure. However, these are not the preferred protein source due to their high price.

It is anticipated that the greater the proteins ability to reform cross-links during the manufacturing process the more brittle the resulting plastics material will be, and the more thermosetting-like properties the product will have.

Applicants have found that the use of particular denaturing agents and additives in the processing of blood proteins allows a more ductile plastic material to be produced. This is due to the potential use of appropriate additives to limit or prohibit the formation of cross-links during the manufacturing process, and thus form a product with more thermoplastic-like properties.

In a preferred embodiment, the protein source may be in one of any number of physical forms prior to processing. For example, the protein source may be in a liquid or aqueous phase prior to and/or after the denaturing agent has been added. However, this should not be seen as limiting as the protein source may also be in a dried, powdered, solid, slurry or gel-like form prior to and/or after addition of the denaturing agent.

In a preferred embodiment, the denaturing agent may be any agent which results in the denaturation of proteins into a lower structured or folded protein than the original protein.

In a preferred embodiment, the denaturing agent may act to disrupt or break protein-protein interactions such that the protein is in a fully unfolded or secondary structure configuration, and shall be referred to as such herein. However, this should not be seen as limiting, as in some situations it may be desirable for the protein to retain some of its secondary, tertiary, or quaternary structure.

In one preferred embodiment, the denaturing agent may be a combination of two or more denaturing agents, and shall be referred to as such herein.

In a preferred embodiment one, of the denaturing agents may be sodium sulfite or a functional equivalent thereof. Sodium sulfite is known to break disulphide bonds. Other reducing agents can be used. However these are harmful and toxic, area not suitable for an environmentally friendly material.

Sodium sulfite is added to proteins to cleave disulphide bonds that produce larger aggregates insoluble even in urea (Areas, 1992).

The literature reveals that sodium sulfite solutions produced the best results in protein extrusion, as measured by the decrease in viscosity of the extruded material, when used in 3-4 wt % of the protein concentration (Zhang et al 1998; Mizani et al, 2005; Orliac et al, 2003; Barone and Schmidt et al, 2006).

Urea, sodium sulfite, metabisulfite, sulfuric acid, and ammonia can all be considered as preservatives (hence anti-oxidant) for blood (Francis, 2000).

In a preferred embodiment, one of the denaturing agents may be urea or a functional equivalent thereof. Urea is a denaturant, as well as a preservative in blood. Therefore, it may be possible to substitute urea with any other compound having these functionalities. The addition of urea to proteins is believed to break non-covalent interactions (hydrogen bonds, hydrophobic and electrostatic interactions) (Areas, 1992). Usually it is effective only at high concentration (>8 M) (Lapanje, 1978).

It should be appreciated that one advantage of using a compound which is a preservative is that it may also act as an anti-oxidant.

Urea, SDS and sulfuric acid are also denaturants.

In one preferred embodiment, the denaturing agent may be a combination of sodium sulfite, or a functional equivalent thereof, and urea, or a functional equivalent thereof. In another preferred embodiment, one of the denaturing agents may be SDS, or a functional equivalent thereof.

Sodium dodecyl sulfate, also called sodium lauryl sulfate, has the structure of a long acyl chain containing a charged sulfate group (Whitford, 2005). Sodium dodecyl sulfate (SDS) is an ionic detergent. Detergents, by definition, unfold proteins and are effective protein solubilizing agents. Detergents in general can asystematically bind to proteins, giving uncertainties in comparisons of molecular weight. Any ionic detergent bound to the protein would change the apparent charge and thus the isoelectric focusing mobility (Zewert et al, 1992).

SDS binds to almost all proteins destroying native conformation (Whitford, 2005). It is known to disrupt hydrophobic interactions (Boye et al, 2004). SDS causes proteins to unfold, become highly negatively charged and form rod-like protein micelles (Whitford, 2005).

In one preferred embodiment, the denaturing agent may be a combination of sodium sulfite, or a functional equivalent thereof, and SDS, or a functional equivalent thereof.

In a particularly preferred embodiment, the denaturing agent may be a combination of sodium sulfite, or a functional equivalent thereof, SDS, or a functional equivalent thereof, and urea, or a functional equivalent thereof.

It is anticipated by the applicant's that while temperature and pressure can act as denaturing agents, these, if used for this purpose would need to be combined with chemical denaturation, using chemicals such as those described above.

In a preferred embodiment, sodium sulfite is used with SDS and/or urea.

In a preferred embodiment, the protein source, for example dried whole blood protein may make up at least 20% (by weight) of the components in the mixture for processing.

In one preferred embodiment, the protein source may be present within a range of substantially between 20 and 90 percent of the weight of the mixture for processing.

In one preferred embodiment, the protein source may be present within a range of substantially between 45 and 55 percent of the weight of the mixture for processing.

### Total Weight % Range

| Blood Meal | Urea | Water | SS | SDS |
|---|---|---|---|---|
| Min 46.73% | Min 2.51% | Min 12.99% | Min 0.47% | Min 1.45% |
| Max 77.52% | Max 13.89% | Max 42.33% | Max 3.03% | Max 7.35% |

In a preferred embodiment, sodium sulfite may be present substantially between 1 and 10 percent of the weight of the mixture for processing. In a preferred embodiment sodium sulfite may be present substantially between 1 and 4 percent of the weight of the mixture for processing.

In a preferred embodiment, urea may be present substantially between 0 and 30 percent of the weight of the mixture for processing. In a preferred embodiment urea may be present substantially between 15 and 25 percent of the weight of the mixture for processing.

In a preferred embodiment, sufficient denaturing agent may be provided to drive the reaction to completion and in most embodiments all three denaturants are included.

In a preferred embodiment, SDS may be present substantially between 0 and 10 percent of the weight of the mixture for processing. In a preferred embodiment SDS may be present substantially between 0.5 and 2.5 percent of the weight of the mixture for processing.

In a preferred embodiment, the remainder of the mixture for processing will be made up of water. In a preferred embodiment water may be present at above substantially 20% (weight/weight of blood meal), and preferably at approximately 60% (weight/weight of blood meal) which is approximately 30% of total weight. In a preferred embodiment water may be present at substantially between 5 and 50 percent of the weight of the mixture for processing.

It should be appreciated that the above concentrations are examples only, and may differ depending on the combination of denaturing agents used in the preparation.

In a preferred embodiment, the denaturing agent may be in an aqueous solution.

Urea is believed to be interchangeable with SDS when used in combination with a reducing agent. These may act by a similar mechanism; however, this has not been confirmed. The applicants believe that the same product may be obtained when either of these additives is used in the manufacture; however, this may have some differing properties such as strength, brittleness, plasticity, or other physical or chemical properties.

The applicants anticipate that the combination of denaturing agents utilized in the present disclosure results in the rearrangement of interactions between protein molecules which leads to different structures which result in the blood proteins being more easily processed. In a preferred embodiment, the denaturing agent may act to break the secondary and/or tertiary and/or quaternary structure of, or between the proteins, however preferably they do not act to cleave the primary protein amino acid (peptide) sequence. However, this should not be seen as limiting, as in some embodiments, some cleaving of the protein source may be desirable. This may include the breaking of disulphide bonds between adjacent proteins, or portions thereof. Cleaving of disulfide or peptide bonds of at least a portion of the protein source may increase the strength or desired properties of the plastics material, such as malleability and brittleness, or lack thereof. This may result either directly from the cleaving action, or when additional additives, such as plasticizers are included in the processing mixture.

In a preferred embodiment, at least one of the denaturing agents utilized may also act to control or prevent cross links from forming during reconstitution of the protein source into a plastics material, and shall be referred to as such herein. In an alternative embodiment, additional additives may be utilized to control or prevent cross links from forming during reconstitution of the protein source into a plastics material. In a preferred embodiment, sodium sulfite may be the denaturing agent which acts to control or prevent cross links from forming. Therefore, in preferred embodiments, the mixture to be processed may contain a sufficient amount of sodium sulfite to prevent or control cross linking.

Sodium sulfite is known to act to break or cleave di-sulfide bonds between proteins or portions thereof by the following reaction:

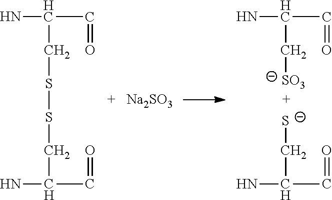

Sodium sulfite is bound up during this process. However, the use of excess sodium sulfite may act to prevent (or break once formed) any new di-sulfide bonds from being formed. Sodium sulfite is also believed to prevent the formation of cross-links between cysteine and/or serine with lysine, which occur in alkaline conditions in the presence of heat.

Cysteine, a sulfur containing amino acid, is found to be involved in non-disulfide irreversible covalent cross-linking (lysinoalanine and others) when proteins are placed under high temperature. Lysinoalanine is an un-natural covalent crosslink that occurs through the formation of dehydroalanine and reactive lysl residues occurs, in alkaline and heated systems. Cystine disulfide bonds form dehydro-residues in alkaline conditions, which are the reactive precursors for lysinoalanine. These non-disulfide covalent crosslinks once formed do not melt or exchange at high temperatures (Mohammed et al, 2000). Their formation in a high protein system can prevent a flowable melt material forming.

In a preferred embodiment, the formation of a plastics material may be due to the formation of desirable secondary interactions between adjacent proteins, or portions thereof. For example, the literature currently shows that reconfiguring a protein structure from an alpha-helix structure to beta-sheet structure improves processing—i.e. interactions were broken and other interactions were formed during processing.

The properties of the resulting plastics material is dependent upon the denaturing agents utilized and the conditions under which consolidation occurs. These factors will influence whether the plastics material is soft and pliable, i.e. thermoplastic-like, or hard and brittle, i.e. thermosetting-like.

In a preferred embodiment, the denatured protein solution may be consolidated by the treatment with a combination of high temperature and high pressure. It is anticipated that the temperature and pressure provide a synergistic effect in addition to the denaturing agents discussed above. This allows protein sources, which have previously not been processed into plastics materials, to be utilized. It is anticipated that the pressure contributes to consolidation by increasing the proximity between denatured proteins. This contributes and facilitates the reformation of protein-protein interactions required to consolidate the denatured protein into the final product—a plastics material. Another result of the high pressure may be that it contributes to the denaturation of proteins, thereby exposing appropriate protein groups and side chains for interaction with other adjacent proteins, or portions thereof.

It is anticipated that high temperature also facilitates the re-formation of protein-protein cross-links and interactions. High temperature has previously been shown to cause or increase the cross-linking or interaction between blood proteins. In a preferred embodiment, the temperature required for the consolidation of the denatured protein source may be greater than the activation temperature or energy required for the chemical reaction. It is also anticipated that high temperature may decrease the viscosity of the system which in turn makes it easier for components to react with one another. In a preferred embodiment, the temperature required for the consolidation of the denatured protein source may be at least approximately 80° C. In a preferred embodiment, the temperature utilized for the consolidation of the denatured protein source using either extrusion or injection molding may be less than, or substantially 130° C. In one preferred embodiment, the temperature may be 115° C. It should be appreciated that the temperature used may depend on the method utilized to extrude or mold the plastic material. For example lower temperatures would be likely to be utilized in an extruder than when injection molding. This is due to water being able to exit the system as vapor, which is not possible during injection molding.

Due to water being utilized as a plasticizer different properties of the plastics material will also be obtained for different conditions in different methods. In a preferred embodiment, the plastics material of the present disclosure may be molded using a closed system, such as injection molding rather than an open system, such as an extruder. For example, using the same components injection molding resulted in more desirable properties. This may be due to the presence of “super-heated” water and higher pressure than what can be obtained in an extruder. In an extruder, heated water can be lost as vapor and the majority of pressure is due to back pressure. The injection mold cannot take powder material only granulated material. Therefore injection molding occurs after extrusion.

In a preferred embodiment, the pressure required for the consolidation of the denatured protein source may be at least approximately 5 MPa. In a preferred embodiment, the pressure may be approximately 3 MPa. Pressure of this level is desired as it forces the components into close proximity with one another, this is especially the case when the viscosity of the processing mixture is high. The pressure utilized may also affect the reformation of di-sulfide bonds. This may be due to the increased proximity of proteins or portions thereof, or the presence of water at a high temperature and pressure.

It should be appreciated that in processes such as thermoforming (such as compression molding) there is a relationship between the temperature and pressure required. For example, as the temperature is lowered, higher pressure is required. This is due to the processing mixture having a higher viscosity at lower temperatures, the mixture therefore requiring higher pressure.

It should be appreciated that consolidation results from the formation of protein-protein cross-links or interactions. These may be, or include any normal protein-protein interaction between molecules. In a preferred embodiment, the processing mixture or slurry of denatured protein may have increased temperature and pressure applied in a heated press, or molding apparatus, such as those for extrusion or injection molding. However, this should not be seen as limiting as any other suitable method known to one skilled in the art may be utilized in the present disclosure. If cross-linking within the mixture can be controlled or prohibited during consolidation it will also be possible to use other plastic molding methods, for example, extrusion. At a sufficient temperature and pressure the denatured protein slurry solidifies into a plastic material. So far the applicant's experimentation has shown that the resulting plastics material may be either a thermoplastic-like plastic material product which can be remolded and extruded, or a thermosetting-like plastic material product which does not soften when reheated.

The applicants believe that this may be controlled or altered by controlling the number of cross-links which re-form during consolidation. For example, if less cross-links form the product may have more thermoplastic properties. Alternatively, this property may be due to a particular form of cross-linking or interaction being more prevalent. For example, a greater number of disulphide bonds may provide more thermosetting properties than if a weaker interaction were most prevalent, for example Van der Waal forces. This is due to the irreversible nature of disulphide bonds, compared to other interactions which can be broken by increasing the temperature, or alternatively the addition of plasticizers.

When controlling the reformation of cross-links it is anticipated that this may be controlling of disulfide bridges between proteins or portions thereof. The strength of the final product is, in part, provided by the reformation of cross-linking such as disulphide bonds and secondary interactions.

In a preferred embodiment, the formation of cross-links and protein interactions during consolidation may be controlled by the addition of chemicals which prevent these interactions forming. The formation of cross-links is believed to be controlled and/or prevented mainly by the action of the chemical denaturing agents, such as sodium sulfite. Di-sulfide bonds, which are one of the main forms of cross-links controlled, can be broken by increased heat. However, the heat required to break would also lead to the breaking of peptide bonds. This is undesirable during the consolidation process. However, this should not be seen as limiting, as the control and/or prevention of cross linking may be via physical means, or a combination of physical and chemical means. It should be appreciated that the conditions need to be chosen appropriately to minimize side reactions, such as cross-linking through cysteine and serine amino acids.

In some embodiments, at least one further additive may be added to the protein slurry to result in a thermoplastic-like product. Additional additives may include, but are not limited to glycerol, PEG, oleic acid or other common plasticizers. The addition of plasticizers such as these may also result in a lower amount of water being required. Water makes analyzing the material difficult, and also water can evaporate changing the mechanical properties of the material. Reducing the water content produces a stiffer the material. Applicants believe that the denaturing agents utilized such as urea and SDS, which may be used as plasticizers in other cases, do not act in this manner on their own. The present disclosure requires the use of denaturing agents and water, which acts as a plasticizer.

In a preferred embodiment, the plastics material may be biodegradable. It should be appreciated by one skilled in the art that if the product is not particularly biodegradable due to high cross-linking or other reasons then biodegradability can be induced by adding at least one chemical additive which can prevent the formation of disulphide bonds.

In some embodiments, the plastic material may be reinforced by the addition of fibers to the protein slurry prior to treatment with temperature and pressure.

According to another aspect of the present disclosure, there is provided a plastics material produced substantially by the method herein described. It is anticipated that the plastics material may be used for a wide variety of purposes for example seeding planters, and as a general material for building, pallets etc.

The protein based plastics material of the present disclosure have a number of significant advantages over current plastics materials, including the following:
utilizes a high volume, low cost protein source,
allows production of a thermoplastic product which does not require the addition of plasticizers,
environmentally friendly,
decreases the volume of petroleum based plastic material required, and
method of manufacture can be readily scaled up.
   Plastic Materials Manufactured from Decolorized Blood Protein

The present disclosure also provides methods for the manufacturing of plastic materials from decolorized blood protein. The methods are carried out by decolorizing the blood protein and manufacturing the decolorized blood protein into a plastic material. The methods comprise contacting the blood protein with an oxidizing agent to form a blood protein composition that includes unreacted oxidizing agent; removing at least a portion of the unreacted oxidizing agent from the blood protein composition to form a decolorized blood protein composition; and treating the decolorized blood protein composition in the presence of a plasticizer with sufficient pressure and temperature to form the plastic material. In some embodiments, the method further comprises contacting the decolorized blood protein composition with a denaturing agent prior to the treating step. In some embodiments, the oxidizing agent is peracetic acid, hydrogen peroxide, sodium chlorite, sodium hypochlorite, sodium chlorate, copper sulfate, sodium peroxide, calcium peroxide, potassium peroxide, or nitrates. In some embodiments, the oxidizing agent is peracetic acid, hydrogen peroxide, sodium chlorite, or sodium hypochlorite. In some embodiments, the oxidizing agent is peracetic acid. In some embodiments, the oxidizing agent is hydrogen peroxide. In some embodiments, the oxidizing agent is sodium chlorite. In some embodiments, the oxidizing agent is sodium hypochlorite.

Peracetic acid (also known as peroxyacetic acid) is a clear liquid with a strong vinegar smell and low pH. It is produced commercially by reacting acetic acid with hydrogen peroxide in the presence of a catalyst and sold as an equilibrium mixture containing peracetic acid, acetic acid, hydrogen peroxide and water. Non-equilibrium mixtures can be produced using distillation to remove acetic acid, hydrogen peroxide, and water. The structure of peracetic acid is as follows:

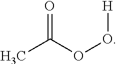

Due to growing concerns over the environmental impact of chlorine use, peracetic acid has been suggested as an alternative for use in waste water treatment and pulp and textile bleaching. Peracetic acid is also commonly used as a food and surface sanitizer. If discharged into the environment, peracetic acid decomposes rapidly and bioaccumulation is unlikely to occur.

In some embodiments, the blood protein source may be whole blood. However, this should not be seen as limiting as any protein containing fraction of blood may be utilized. Protein containing fractions of blood may include isolated red blood cells, serum, or other isolated fractions from whole blood. As described above, the whole blood may be derived from one or more animal species, such as, for example, bovines. In some embodiments, the blood protein source may be blood meal or spray dried hemoglobin.

### Blood Meal as Decolorized Blood Protein Source

In some embodiments, the blood protein source that is decolorized prior to manufacturing into a plastic material is blood meal. In some embodiments where the blood protein source is blood meal, 1-5% (weight/weight or “w/w”) peracetic acid solutions are used to decolor the blood meal. In some embodiments, 3-5% (w/w) peracetic acid solutions are used to decolor and deodor the blood meal. In some embodiments, 5-40% (w/w) hydrogen peroxide solutions are used to decolor and deodor the blood meal. In some embodiments, 1-10% (w/w) sodium chlorite solutions are used to decolor and deodor the blood meal. In some embodiments, 5-15% (w/w) sodium hypochlorite solutions are used to decolor and deodor the blood meal.

Once the blood meal is decolorized and/or deodorized, a denaturing agent may or may not be contacted with the decolorized blood composition prior to the treating step to form the plastic material. Although a denaturing agent is not required to form a plastic material from the decolorized blood composition, the denaturing agent may improve the quality of the plastic material. In some embodiments, the denaturing agent is SDS. In some embodiments, one or more additives may be combined with the denaturing agent before contacting with the decolorized blood protein. In some embodiments, the additive is borax, sodium silicate, sodium bentonite, amine modified clay (also referred to herein as “modified clay”), or mixtures thereof. In some embodiments, the additives are added to the blood meal at a concentration of 1-5 parts per hundred or “ppH” (e.g., 1-5 g per 100 g of blood meal). In some embodiments, the blood meal is treated with a 4% peracetic acid solution prior to treatment with a denaturing agent in combination with an additive.

In some embodiments, the plasticizer is ethylene glycol, diethylene glycol, triethylene glycol (TEG), polyethylene glycol, glycerol, 1,2-propanediol, triacetin, triethyl citrate, tributyl citrate, epoxidized soybean oil, or mixtures thereof. In some embodiments, the plasticizer is ethylene glycol, diethylene glycol, triethylene glycol, polyethylene glycol, 1,2-propanediol, glycerol, or mixtures thereof. In some preferred embodiments, the plasticizer is triethylene glycol.

### Spray Dried Hemoglobin as Decolorized Blood Protein Source

In some embodiments, the blood protein source that is decolorized prior to manufacturing into a plastic material is spray dried hemoglobin. In some embodiments, the spray dried hemoglobin is added to the oxidizing agent aqueous solution to decolor and/or deodor the spray dried hemoglobin. In some preferred embodiments the spray dried hemoglobin is added to the peracetic acid aqueous solution to decolor the spray dried hemoglobin.

In some embodiments where the blood protein source is spray dried hemoglobin, the ratio of peracetic acid to spray dried hemoglobin (by weight) is 2.5-3.5:1. In some embodiments, 2.5-3.5% (w/w) peracetic acid solutions are used to decolor the spray dried hemoglobin. In some preferred embodiments, a ratio of about 3:1 peracetic acid to spray dried hemoglobin with a 3% peracetic acid solution is used to decolor the spray dried hemoglobin.

Once the spray dried hemoglobin is decolorized, a denaturing agent may or may not be contacted with the decolorized blood composition prior to the treating step to form the plastic material. Although a denaturing agent is not required to form a plastic material from the decolorized blood composition, the denaturing agent may improve the quality of the plastic material. In some embodiments, the denaturing agent is SDS. In other embodiments, the denaturing agent is a mixture of SDS and sodium sulfite (SS).

In some embodiments, the plasticizer is ethylene glycol, diethylene glycol, triethylene glycol, polyethylene glycol, glycerol, 1,2-propanediol, triacetin, triethyl citrate, tributyl citrate, epoxidized soybean oil, or mixtures thereof. In some embodiments, the plasticizer is ethylene glycol, diethylene glycol, triethylene glycol, 1,2-propanediol, glycerol, or mixtures thereof. In some preferred embodiments, the plasticizer is ethylene glycol or glycerol. In some preferred embodiments, the plasticizer is 1,2-propanediol. In some preferred embodiments, the plasticizer is triethylene glycol.

### EXAMPLES

The following examples are offered to illustrate but not to limit the invention.

### General Chemistry

Peracetic acid solutions (1-5% w/w) were prepared by diluting 5% peracetic acid with the required amount of distilled water. A 15% peracetic acid sample was obtained from Degussa New Zealand and used without modification. Freeze drying was accomplished with a Labconco Freezone 2.5 Freeze Dryer, although samples may be alternatively dried in a normal oven. Color analysis of dried powders was accomplished with a Minolta Chroma Meter CR-200b set in L*a*b* (CIE 1976) mode using D (6504K) illuminant conditions. L*a*b* values were converted to RGB and percent whiteness calculated using the equation: percent whiteness=(R+G+B) 1765×100.

Peracetic acid treatment requires cooling the reaction vessel because heat is produced during the decolorization treatment. The heat is caused by peracetic acid reacting with the iron in blood meal as well as peracetic acid decomposition. The amount of heat generated increases as the amount of blood meal being treated increases. Large batches will require sufficient cooling and stirring to maintain the temperature at safe working limits and also to protect the protein from thermal hydrolysis. Heat removed by cooling water can be cycled around the processing plant for use in other areas.

The reaction vessel must also be vented to allow the release of gases given off during the decolorization treatment. The main gases produced are oxygen and carbon dioxide. These must be vented to prevent over pressurization of the reaction vessel.

Aqueous solutions of oxidizing agents were prepared by diluting commercially available solutions or by dissolving the oxidizing agent in distilled water.

### Example 1

### Blood Meal Decolorization and Deodorization

5 g of blood meal (95% solids) were added to preweighed beakers. The blood meal was treated with 20 mL of 1-5% (w/w) peracetic acid solutions or other oxidizing agents as specified in Tables 1 and 2. The contents were stirred for 1 hour then filtered and washed with distilled water using a Buchner funnel and Whatman grade 1 (11 μm cut off) filter paper. The treated blood meal was freeze dried overnight. Dried samples were ground to a fine power using a mortar and pestle and analyzed using the Chroma Meter. The color and odor analysis results are reported in Tables 1 and 2.

### Example 2

### Red Blood Cell (RBC) Decolorization and Deodorization

5 g of red blood cells were added to preweighed beakers. The red blood cells were treated with 20 mL of 1-5% (w/w) peracetic acid solutions or other oxidizing agents as specified in Tables 1 and 3. The contents were stirred for 1 hour then freeze dried overnight. Dried samples were ground to a fine power using a mortar and pestle and analyzed using the Chroma Meter. The color and odor analysis results are reported in Tables 1 and 3.

### Example 3

### Modified Red Blood Cell (mRBC) Decolorization and Deodorization

5 g of red blood cells were added to preweighed beakers. The red blood cells were diluted with 20 mL distilled water and lowered to pH 2 using 1 mol/L HCl. The solutions were centrifuged at 4000 rpm for 5 minutes using a Sigma 6-15 centrifuge. The supernatant was decanted and treated with 20 mL of oxidizing agents as specified in Tables 1 and 4. The contents were stirred for 1 hour then freeze dried overnight. Dried samples were ground to a fine power using a mortar and pestle and analyzed using the Chroma Meter. The color and odor analysis results are reported in Tables 1 and 4.

TABLE 1
Blood meal (BM), red blood cell (RBC), and modified red blood cell
(mRBC) decolorization and deodorization methods with peracetic acid
(PAA) ranked by percent whiteness.

| | | | | | | | | | White- | Smell |
|---|---|---|---|---|---|---|---|---|---|---|
| | Material | Treatment | | | | | | | ness | Mod- |
| Rank | Treated | Method | L | a* | b* | R | G | B | (%) | ified? |
| 1 | RBC | PAA (5%) | 95 | −4 | 17 | 243 | 242 | 208 | 91 | Yes |
| 2 | mRBC | PAA (5%) | 91 | 0 | 17 | 239 | 229 | 199 | 87 | Yes |
| 3 | BM | PAA (15%) | 84 | 0 | 35 | 227 | 208 | 144 | 76 | Yes |
| 4 | BM | PAA (5%) | 77 | 3 | 43 | 215 | 187 | 111 | 67 | Yes |
| 5 | BM | PAA (4%) | 74 | 4 | 43 | 208 | 178 | 104 | 64 | Yes |
| 6 | BM | PAA (3%) | 72 | 6 | 41 | 206 | 172 | 103 | 63 | Yes |
| 7 | BM | PAA (2%) | 64 | 7 | 36 | 182 | 149 | 91 | 55 | No |
| 8 | BM | PAA (1%) | 54 | 8 | 30 | 155 | 124 | 79 | 47 | No |
| 9 | RBC | untreated | 30 | 22 | 10 | 106 | 57 | 58 | 29 | No |
| 10 | mRBC | untreated | 28 | 6 | 8 | 79 | 62 | 54 | 25 | No |
| 11 | BM | untreated | 20 | 7 | 5 | 61 | 45 | 42 | 19 | No |
| 12 | BM | distilled | 18 | 10 | 5 | 60 | 39 | 38 | 18 | No |
| | | water | | | | | | | | |

TABLE 2
Blood Meal (BM) decolorization and deodorization methods with
oxidizing agents ranked by percent whiteness.

| | Material | Treatment | | | | | Whiteness | Smell |
|---|---|---|---|---|---|---|---|---|
| Rank | Treated | Method | L | R | G | B | (%) | Modified? |
| 1 | BM | PAA | 84 | 227 | 208 | 144 | 76 | Yes |
| | | (15%) | | | | | | |
| 2 | BM | PAA | 77 | 215 | 187 | 111 | 67 | Yes |
| | | (5%) | | | | | | |
| 3 | BM | H₂O₂ | 67 | 187 | 154 | 109 | 59 | Yes |
| | | (30%) | | | | | | |
| 4 | BM | H₂O₂ | 66 | 183 | 153 | 102 | 57 | No |
| | | (15%) | | | | | | |
| 5 | BM | H₂O₂ | 52 | 149 | 119 | 79 | 45 | No |
| | | (5%) | | | | | | |
| 6 | BM | NaClO₂ | 35 | 103 | 77 | 56 | 31 | Yes |
| | | (5%) | | | | | | |
| 7 | BM | Untreated | 20 | 61 | 45 | 42 | 19 | No |
| 8 | BM | NaClO | 20 | 64 | 43 | 39 | 19 | No |
| | | (5%) | | | | | | |
| 9 | BM | NaClO | 20 | 57 | 46 | 40 | 19 | No |
| | | (10%) | | | | | | |
| 10 | BM | NaClO₃ | 19 | 65 | 39 | 38 | 19 | No |
| | | (5%) | | | | | | |
| 11 | BM | NaClO | 19 | 51 | 45 | 42 | 18 | No |
| | | (15%) | | | | | | |
| 12 | BM | Distilled | 18 | 60 | 39 | 38 | 18 | No |
| | | Water | | | | | | |
| 13 | BM | ClO₂ | 18 | 60 | 39 | 38 | 18 | No |
| | | (2%) | | | | | | |
| 14 | BM | CuSO₄ | 19 | 51 | 45 | 40 | 18 | No |
| | | (5%) | | | | | | |

TABLE 3
Red blood cell (RBC) decolorization and deodorization methods with
oxidizing agents ranked by percent whiteness.

| | Material | Treatment | | | | | Whiteness | Smell |
|---|---|---|---|---|---|---|---|---|
| Rank | Treated | Method | L | R | G | B | (%) | Modified? |
| 1 | RBC | PAA | 95 | 243 | 242 | 208 | 91 | Yes |
| | | (5%) | | | | | | |
| 2 | RBC | H₂O₂ | 77 | 218 | 184 | 139 | 71 | Yes |
| | | (30%) | | | | | | |
| 3 | RBC | NaClO₂ | 67 | 188 | 157 | 123 | 61 | Yes |
| | | (5%) | | | | | | |
| 4 | RBC | NaClO | 65 | 165 | 157 | 144 | 61 | No |
| | | (15%) | | | | | | |
| 5 | RBC | NaClO | 64 | 161 | 155 | 138 | 59 | No |
| | | (10%) | | | | | | |
| 6 | RBC | NaClO | 58 | 148 | 138 | 132 | 55 | No |
| | | (5%) | | | | | | |
| 7 | RBC | ClO₂ | 35 | 126 | 63 | 62 | 33 | No |
| | | (2%) | | | | | | |
| 8 | RBC | CuSO₄ | 33 | 86 | 76 | 67 | 30 | No |
| | | (5%) | | | | | | |
| 9 | RBC | Untreated | 28 | 106 | 57 | 58 | 29 | No |
| 10 | RBC | NaClO₃ | 27 | 86 | 56 | 54 | 26 | No |
| | | (5%) | | | | | | |

TABLE 4
Modified red blood cell (mRBC) decolorization and deodorization
methods with oxidizing agents ranked by percent whiteness.

| | Material | Treatment | | | | | Whiteness | Smell |
|---|---|---|---|---|---|---|---|---|
| Rank | Treated | Method | L | R | G | B | (%) | Modified? |
| 1 | mRBC | NaClO₂ | 95 | 246 | 240 | 225 | 93 | Yes |
| | | (5%) | | | | | | |
| 2 | mRBC | PAA | 91 | 239 | 229 | 199 | 87 | Yes |
| | | (5%) | | | | | | |
| 3 | mRBC | H₂O₂ | 64 | 180 | 147 | 92 | 55 | Yes |
| | | (30%) | | | | | | |
| 4 | mRBC | NaClO | 49 | 125 | 115 | 100 | 44 | No |
| | | (10%) | | | | | | |
| 5 | mRBC | NaClO | 47 | 121 | 110 | 102 | 44 | No |
| | | (5%) | | | | | | |
| 6 | mRBC | NaClO | 47 | 129 | 107 | 94 | 43 | No |
| | | (15%) | | | | | | |
| 7 | mRBC | CuSO₄ | 29 | 82 | 65 | 52 | 26 | No |
| | | (5%) | | | | | | |
| 8 | mRBC | Untreated | 28 | 79 | 62 | 54 | 25 | No |
| 9 | mRBC | ClO₂ | 27 | 79 | 60 | 51 | 25 | No |
| | | (2%) | | | | | | |
| 10 | mRBC | NaClO₃ | 23 | 69 | 51 | 46 | 22 | No |
| | | (5%) | | | | | | |

### Example 4

### Blood Meal and Red Blood Cell Molecular Mass Distribution

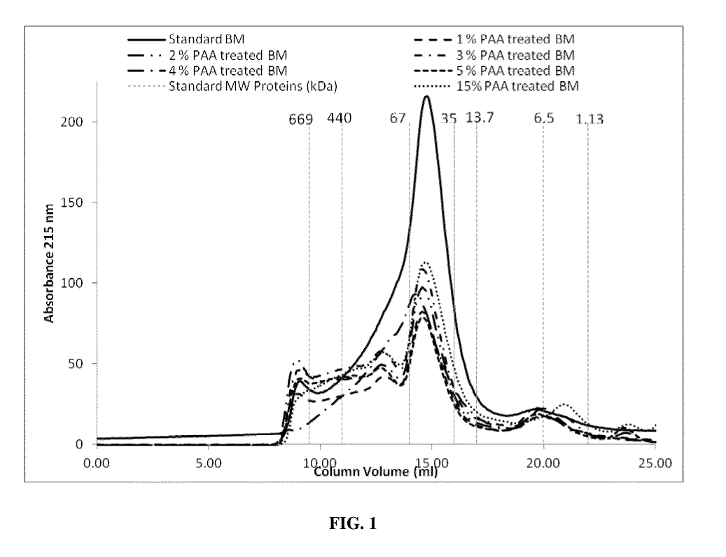

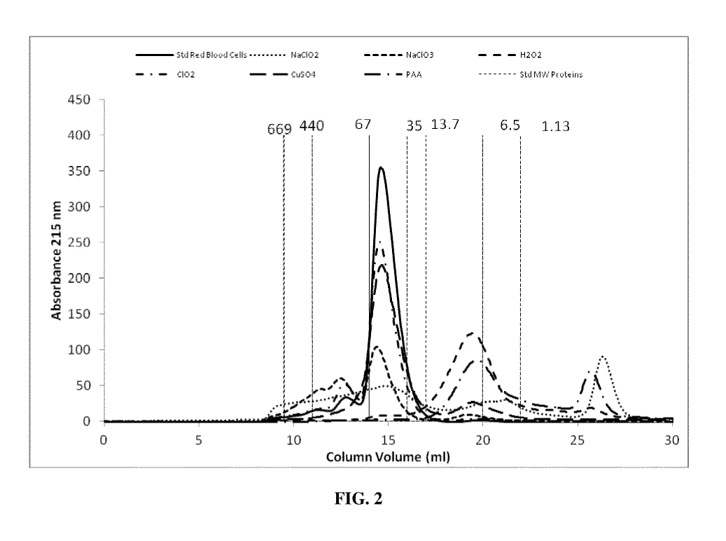

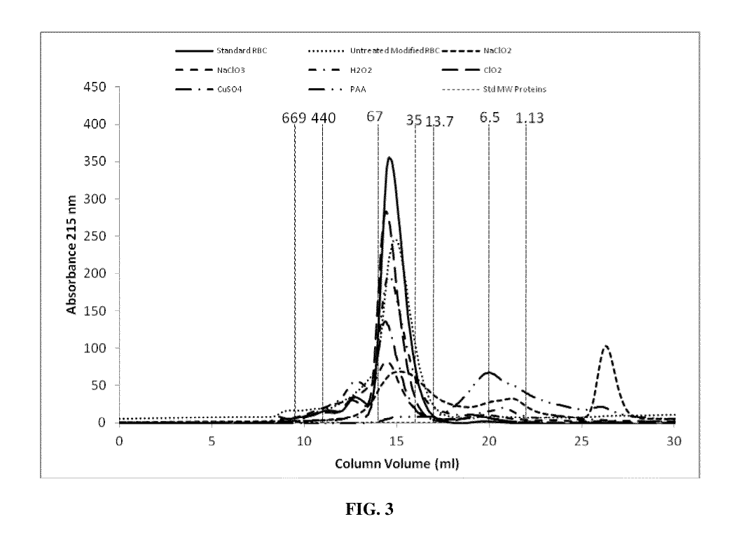

0.02 mol/L phosphate buffer containing 0.5% sodium sulfite, 0.1 M sodium chloride, and 2% sodium dodecyl sulfate at pH 7 was prepared by dissolving the required weights of sodium dihydrogen phosphate, sodium dihydrogen orthophosphate, sodium sulfite, sodium chloride, and sodium dodecyl sulfate in distilled water and adjusting to pH 7 using hydrochloric acid or sodium hydroxide. 8-9 mg samples were dissolved in 2.5 ml 0.02 mol/L phosphate buffer at pH 7 containing 0.5% SS, 0.1 M NaCl, and 2% SDS and boiled for 5 minutes at 100° C. Dissolved samples were run through a Superdex 200 10/300 gel filtration column attached to an Akta Explorer 100 (GE Healthcare). The running buffer was 0.02 M phosphate buffer at pH 7 containing 0.1M NaCl and 0.1% SDS at a flow rate of 0.5 ml/min. The protein concentration measured at 215 nm using an inline detector. The molecular weight results of the blood meal, red blood cell, and modified red blood cells after peracetic acid treatment are shown in FIG. 1-3.

### Example 5

### Ranking Methods Based on Combined Results for Peracetic Acid

The methods were ranked by combining the results for color removal, smell modification, and protein molecular weight. Points were assigned to each component and the methods ranked based on the highest total score. Ranking of the combined results are shown in Table 5.

The points were assigned as follows:

Color: Max 100. Points assigned were equal to percentage whiteness. For example, untreated BM is 19% white and is assigned 19 points.

Smell: Max 100. If the smell was improved—100 points. If the smell was not improved—0 points.

Molecular weight: Max 100. If the main peak has not shifted from original column volume position—100 points. If the main peak has shifted to the right (increased column volume)—0 points.

TABLE 5
Blood meal (BM), red blood cell (RBC), and modified red blood cell (mRBC)
decolorization methods with peracetic acid (PAA) ranked based on combined results.

| | | | Percent | Smell | Color | Smell | MW | Total |
|---|---|---|---|---|---|---|---|---|
| Rank | Material | Treatment | Whiteness | Modified | (max 100) | (max 100) | (max 100) | (max 300) |
| 1 | BM | PAA (5%) | 67 | Yes | 67 | 100 | 100 | 267 |
| 2 | BM | PAA (4%) | 64 | Yes | 64 | 100 | 100 | 264 |
| 3 | BM | PAA (3%) | 63 | Yes | 63 | 100 | 100 | 263 |
| 12 | RBC | PAA (5%) | 91 | Yes | 91 | 100 | 0 | 191 |
| 14 | mRBC | PAA (5%) | 87 | Yes | 87 | 100 | 0 | 187 |
| 15 | BM | PAA (15%) | 76 | Yes | 76 | 100 | 0 | 176 |
| 19 | BM | PAA (2%) | 55 | No | 55 | 0 | 100 | 155 |
| 20 | BM | PAA (1%) | 47 | No | 47 | 0 | 100 | 147 |
| 25 | RBC | Untreated | 29 | No | 29 | 0 | 100 | 129 |
| 28 | mRBC | Untreated | 25 | No | 25 | 0 | 100 | 125 |
| 31 | BM | Untreated | 19 | No | 19 | 0 | 100 | 119 |
| 36 | BM | Distilled | 18 | No | 18 | 0 | 100 | 118 |
| | | Water | | | | | | |

### Example 6

### Ranking Methods Based on Combined Results for Oxidizing Agents

The methods were ranked by combining the results for color removal, smell modification, simplicity of process, speed, environmental friendliness, and protein molecular weight. Points were assigned to each component and the methods ranked based on the highest total score. Ranking of the combined results are shown in Table 6.

The points were assigned as follows:

Color: Max 100. Points assigned were equal to percentage whiteness. For example, untreated BM is 19% white and is assigned 19 points.

Smell: Max 100. If the smell was improved—100 points. If the smell was not improved—0 points.

Simplicity of process: Max 100. If the process was simple, i.e. low volumes of feedstocks being handled and few processing steps—100 points. If the process required handling high volumes of feedstocks and many processing steps (diluting, pH adjustment, centrifuging etc.)—0 points.

Speed: Max 100. If color and odor removal occurred within 5 minutes—100 points. If color and odor removal took longer than 5 minutes—0 points.

Environmental Friendliness: Max 100. If there were no environmental concerns—100 points. If there were environmental concerns—0 points

Molecular Weight: Max 100. If the molecular mass was not significantly reduced based on gel elution profiles and number average molecular weight—100 points. If the molecular mass was significantly reduced based on gel elution profiles and number average molecular weight—0 points.

TABLE 6
Blood meal (BM), red blood cell (RBC), and modified red blood cell (mRBC)
decolorization methods with oxidizing agents ranked based on combined results.

| | | | Smell | Color | Smell | Simplicity | Speed | Env. | MW | Total |
|---|---|---|---|---|---|---|---|---|---|---|
| Rank | Material | Treatment | Modified | Points | Points | Points | Points | Points | Points | Points |
| 1 | BM | PAA (15%) | Yes | 76 | 100 | 100 | 100 | 100 | 100 | 576 |
| 2 | BM | PAA (5%) | Yes | 67 | 100 | 100 | 100 | 100 | 100 | 567 |
| 3 | BM | H₂O₂ (30%) | Yes | 59 | 100 | 100 | 100 | 100 | 100 | 559 |
| 4 | BM | H₂O₂ (15%) | No | 57 | 0 | 100 | 100 | 100 | 100 | 457 |
| 5 | BM | H₂O₂ (5%) | No | 45 | 0 | 100 | 100 | 100 | 100 | 445 |
| 6 | RBC | PAA (5%) | Yes | 91 | 100 | 0 | 100 | 100 | 0 | 391 |
| 7 | mRBC | PAA (5%) | Yes | 87 | 100 | 0 | 100 | 100 | 0 | 387 |
| 8 | RBC | H₂O₂ (30%) | Yes | 71 | 100 | 0 | 100 | 100 | 0 | 371 |
| 9 | mRBC | H₂O₂ (30%) | Yes | 55 | 100 | 0 | 0 | 100 | 100 | 355 |
| 10 | BM | Untreated | No | 19 | 0 | 100 | 0 | 100 | 100 | 319 |
| 11 | BM | Distilled Water | No | 18 | 0 | 100 | 0 | 100 | 100 | 318 |
| 12 | BM | NaClO₂ (5%) | Yes | 31 | 100 | 100 | 0 | 0 | N/A | 231 |
| 13 | RBCC | Untreated | No | 29 | 0 | 0 | 0 | 100 | 100 | 229 |
| 14 | mRBC | Untreated | No | 25 | 0 | 0 | 0 | 100 | 100 | 225 |
| 15 | BM | ClO₂ (2%) | No | 18 | 0 | 100 | 0 | 0 | 100 | 218 |
| 16 | BM | CuSO₄ (5%) | No | 18 | 0 | 100 | 0 | 0 | 100 | 218 |
| 17 | mRBC | NaClO₂ (5%) | Yes | 93 | 100 | 0 | 0 | 0 | 0 | 193 |
| 18 | RBCC | NaClO₂ (5%) | Yes | 61 | 100 | 0 | 0 | 0 | 0 | 161 |
| 19 | RBCC | ClO₂ (2%) | No | 33 | 0 | 0 | 0 | 0 | 100 | 133 |
| 20 | RBCC | CuSO₄ (5%) | No | 30 | 0 | 0 | 0 | 0 | 100 | 130 |
| 21 | mRBC | CuSO₄ (5%) | No | 26 | 0 | 0 | 0 | 0 | 100 | 126 |
| 22 | RBCC | NaClO₃ (5%) | No | 26 | 0 | 0 | 0 | 0 | 100 | 126 |
| 23 | mRBC | ClO₂ (2%) | No | 25 | 0 | 0 | 0 | 0 | 100 | 125 |
| 24 | mRBC | NaClO₃ (5%) | No | 22 | 0 | 0 | 0 | 0 | 100 | 122 |
| 25 | BM | NaClO (5%) | No | 19 | 0 | 100 | 0 | 0 | N/A | 119 |
| 26 | BM | NaClO (10%) | No | 19 | 0 | 100 | 0 | 0 | N/A | 119 |
| 27 | BM | NaClO₃ (5%) | No | 19 | 0 | 100 | 0 | 0 | N/A | 119 |
| 28 | BM | NaClO (15%) | No | 18 | 0 | 100 | 0 | 0 | N/A | 118 |
| 29 | RBC | NaClO (15%) | No | 61 | 0 | 0 | 0 | 0 | N/A | 61 |
| 30 | RBC | NaClO (10%) | No | 59 | 0 | 0 | 0 | 0 | N/A | 59 |
| 31 | RBC | NaClO (5%) | No | 55 | 0 | 0 | 0 | 0 | N/A | 55 |
| 32 | mRBC | NaClO (10%) | No | 44 | 0 | 0 | 0 | 0 | N/A | 44 |
| 33 | mRBC | NaClO (5%) | No | 44 | 0 | 0 | 0 | 0 | N/A | 44 |
| 34 | mRBC | NaClO (15%) | No | 43 | 0 | 0 | 0 | 0 | N/A | 43 |

### Example 7

### X-Ray Diffraction

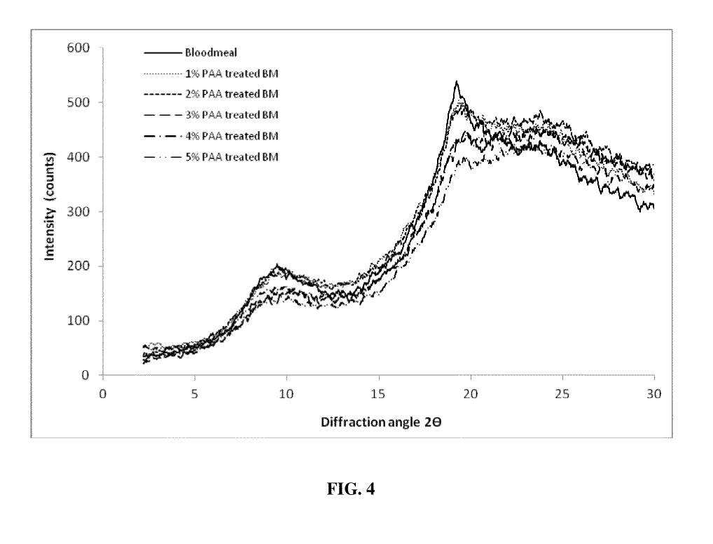

The basal spacing and molecular patterning of polymers and nano-composites were measured using a low angle powder X-ray diffraction. XRD was carried out using a Philips X-ray diffractometer at a low angle configuration of 2θ=2° to 12°, with a scanning rate of 2 θ=2° min⁻¹, operating at a current of 40 mA and a voltage of 40 kV using CuKα₁ radiation. The XRD analysis of peracetic acid treated blood meal is shown in FIG. 4. Increasing the peracetic acid concentration causes a decrease in both inter-helix and intra-helix patterning (FIG. 4). This shows that although chain length has not been severely reduced (FIG. 1), the amount of interactions between proteins is reduced.

### Example 8

### Compression Molding of Decolored Blood Meal

3 ppH SDS was dissolved in 25 ppH distilled water (ppH relative to blood meal). The solution was heated and stirred to 60° C. When producing composites or mixtures with additives, the clay or additives were also added at this step. The hot solution was added to decolored blood meal and mixed in a high speed mixer for 5 minutes. 20 ppH triethylene glycol (TEG) was added and mixed for an additional 5 minutes (ppH relative to blood meal).

Four different additives were compared to each other: borax, sodium silicate, sodium bentonite, and modified clay. Each of these was used with three different concentrations per 100 g of blood meal: 1 ppH, 3 ppH, and 5 ppH.

50 g of compression mixture was placed in the preheated mold and compression molded at 110° C. (top and bottom plate). 10 tons of pressure was applied for 5 minutes. Heating was turned off after 5 minutes and the mold was left under 10 tons of pressure for a further 5 minutes. The pressure was released, the sheet removed and left to cool. The sheets were then laser cut into Type 1 dog bone tensile test specimen.

Tensile specimens were conditioned for 7 days then mechanical properties were examined using a Lloyd Tensile Tester LR 30K with a load cell of 500 N at a speed of 5 mm/min. All samples were assessed on their tensile strength, deflection at break, stress at break, and Young's modulus. The size of all tensile specimens was kept as constant as possible. Each specimen was conditioned for 7 days prior to testing. Each sample was tested at a speed of 5 mm/min.

Sheet color was measured at three randomly selected locations using a Chroma Meter set in L*a*b* (CIE 1976) mode using D (6504K) illuminant conditions. L*a*b* values were converted to RGB and percent whiteness calculated and averages calculated as shown in Table 7. As peracetic acid concentration increases percent whiteness of the compression molded sheet increases. Higher concentrations of peracetic acid will have more active components causing greater decoloring. Comparing Tables 1 and 7 shows that percent whiteness is slightly reduced after compression molding into bioplastic sheets.

TABLE 7
Sheet color of 1-5% (w/w) peracetic acid.

| | | | | | | | Whiteness |
|---|---|---|---|---|---|---|---|
| | L | a* | b* | R | G | B | (%) |
| Untreated BM | 25 | 0 | −1 | 59 | 60 | 61 | 24 |
| 1% PAA BM | 26 | 0 | 0 | 62 | 62 | 62 | 24 |
| 2% PAA BM | 28 | 12 | 6 | 86 | 59 | 58 | 27 |
| 3% PAA BM | 57 | 18 | 52 | 182 | 123 | 43 | 45 |
| 4% PAA BM | 71 | 2 | 54 | 199 | 171 | 72 | 58 |
| 5% PAA BM | 72 | 4 | 43 | 203 | 173 | 99 | 62 |

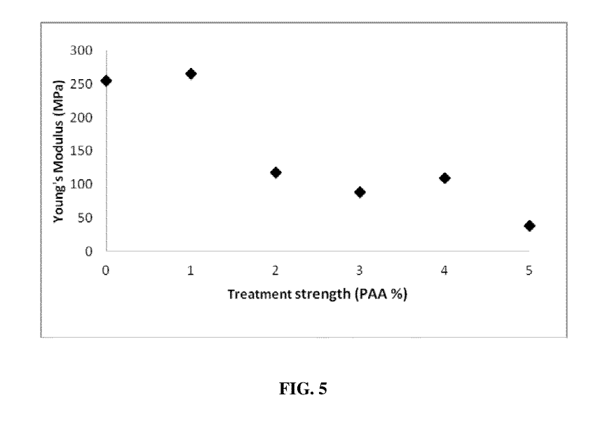

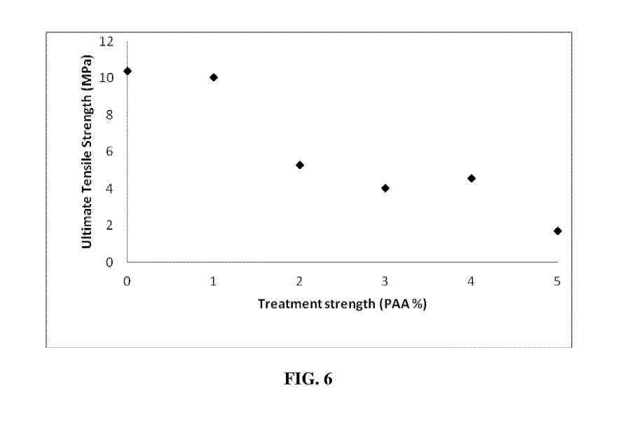

Increasing concentrations of peracetic acid caused Young's modulus to decrease significantly (FIG. 5). Standard BM has a modulus of 255.25 MPa, whereas 5% peracetic acid has decreased to 38.44 MPa. The graph in FIG. 5 also shows a slight increase in modulus of 4% peracetic acid. As peracetic acid concentration increases the ultimate tensile strength lowers (FIG. 6). Standard blood meal had an ultimate tensile strength of 10.40 MPa, whereas 5% peracetic acid treated blood meal only gave 1.71 MPa. As shown in XRD analysis (FIG. 4) increasing peracetic acid treatment concentration causes a decrease in protein patterning which could explain the decrease in strength.

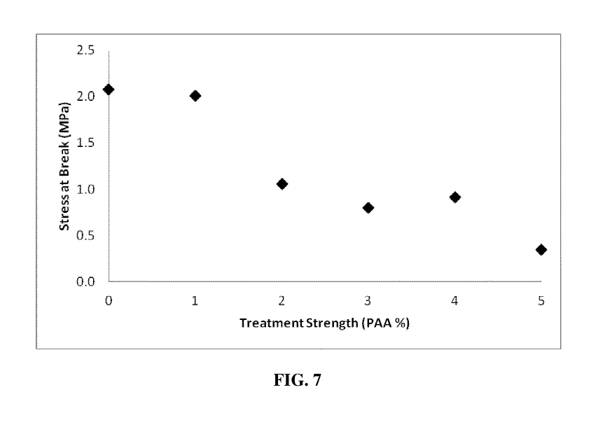

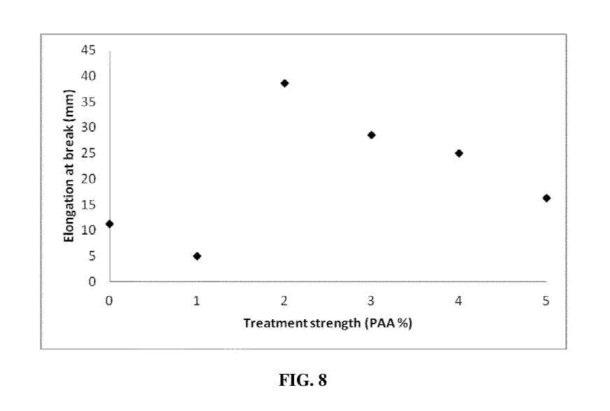

Stress at break of samples has decreased as the concentrations of peracetic acid increased (FIG. 7). Similar to previous figures, a significant change has occurred from the stress required for standard BM of 2.08 MPa to stress required for 5% BM of 0.34 MPa. A similar trend is seen in FIG. 5-8. The results obtained show a decrease in properties with increasing concentration levels of peracetic acid. This could be due to the loss in cystein crosslinks caused by peracetic acid treatment as described in literature. Peracetic acid treatment also causes a decrease in its intermolecular and intramolecular interactions as shown by XRD analysis leading to a more amorphous structure, which could also contribute to a decrease in strength.

Other factors that appeared to have an effect on mechanical properties were vapor bubbles and specimen defects. These bubbles were noticed on the surface of 3-5% peracetic acid specimens. Water vapor trapped in plastic sheets was observed to escape through the formation of bubbles during the release of pressure while compression molding the sheets. While tensile testing specimens, fractures were seen to be caused by bubbles as they showed tearing at the site of bubbles. The 2% peracetic acid molded sheets which did not have many obvious bubbles, showed a higher strength than 3% peracetic acid. However 1 and 2% peracetic acid compression molded sheets were not as translucent, so bubbles could still be present but not as obvious due to the lack of translucency.

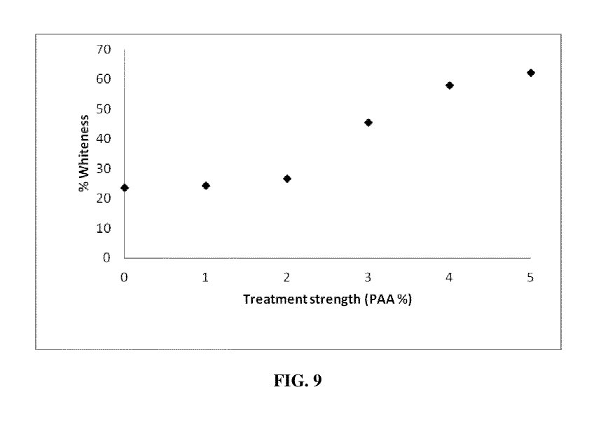

Increasing the strength of peracetic acid treatment causes an increase in whiteness (FIG. 9). Percent whiteness changes very little between 1 and 2% peracetic acid. However between 2 and 3% peracetic acid concentration there is a large increase. At pH 2 the heme porphyrin is released from the globin chain and makes it more susceptible to degradation. At 3% peracetic acid concentration the pH could be sufficiently lowered to cause the release of heme explaining the large increase in percent whiteness.

The 4% peracetic acid treatment was chosen as the best option to trial with clays and additives. This was based on mechanical properties, smell, and color. Results are shown in Table 8.

TABLE 8
Color change for different composite sheets (ppH relative to blood meal).

| 4% peracetic | | | | | | | Whiteness |
|---|---|---|---|---|---|---|---|
| acid + BM | L | a* | b* | R | G | B | (%) |
| 1 pph borax | 64 | 8 | 48 | 187 | 149 | 68 | 53 |
| 3 pph borax | 59 | 15 | 51 | 183 | 131 | 50 | 48 |
| 5 pph borax | 48 | 24 | 38 | 162 | 97 | 51 | 41 |
| 1 pph sodium silicate | 54 | 18 | 41 | 172 | 117 | 59 | 45 |
| 3 pph sodium silicate | 53 | 18 | 35 | 168 | 114 | 68 | 46 |
| 5 pph sodium silicate | 56 | 16 | 43 | 176 | 123 | 60 | 47 |
| 1 pph bentonite clay | 65 | 10 | 43 | 192 | 151 | 81 | 55 |
| 3 pph bentonite clay | 51 | 15 | 34 | 158 | 111 | 65 | 44 |
| 5 pph bentonite clay | 44 | 13 | 26 | 134 | 95 | 62 | 38 |
| 1 pph modified clay | 55 | 16 | 39 | 171 | 120 | 65 | 47 |
| 3 pph modified clay | 57 | 16 | 42 | 179 | 124 | 64 | 48 |
| 5 pph modified clay | 56 | 16 | 40 | 175 | 123 | 66 | 48 |

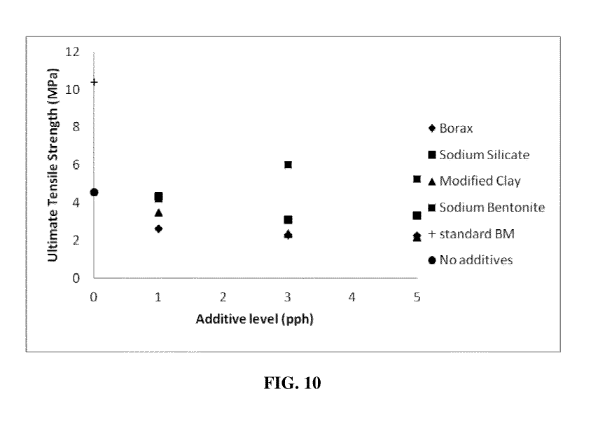

As the concentration of additives and clays increase, the whiteness levels decrease. This can be the result of clays having a dark color. As the concentrations of clays increase, plastic sheets incorporate more of their color giving less whiteness as well as transparency. As shown in FIG. 10, a decrease in the ultimate tensile strength with the addition of additives was observed apart from sodium bentonite at 3-5 pph (relative to blood meal). Modified clay, borax, and sodium silicate decrease the strength of the bioplastic as their levels increase.

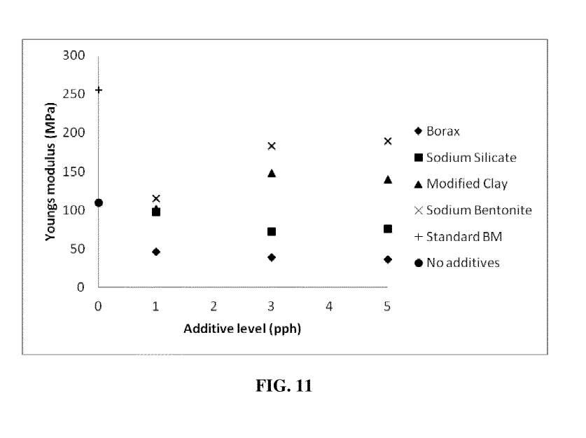

Young's modulus increases as sodium bentonite and modified clay concentration increases as shown in FIG. 11. Whereas sodium silicate and borax show addition causes a decrease Young's modulus as their concentrations increase. The largest increase in Young's modulus was exhibited by sodium bentonite, which could be a result of protein intercalation.

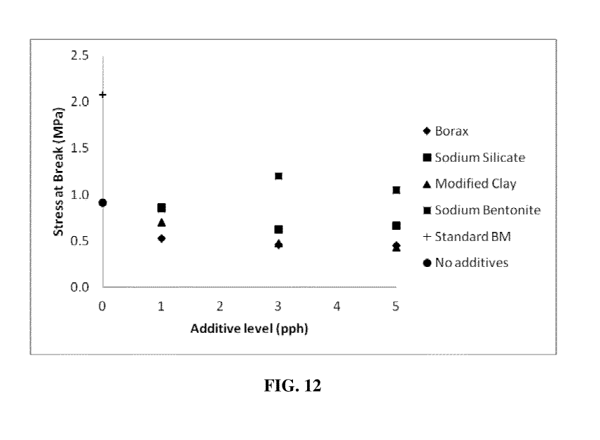

Sodium bentonite increases the stress at break. However modified clay, borax and sodium silicate decrease the stress required at break as their concentration increases (FIG. 12).

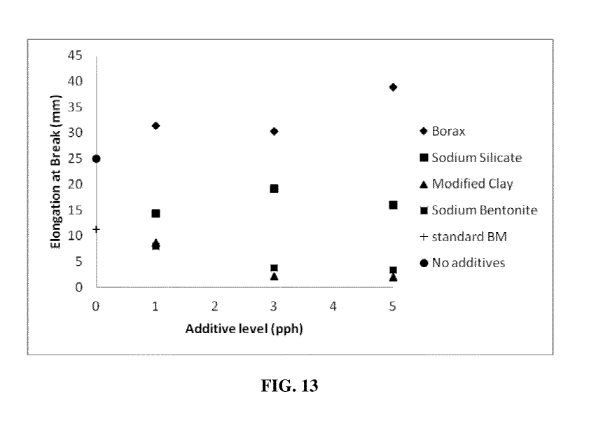

The addition of borax increased the elongation required until fracture. However, sodium silicate and both clays reduced the elongation (FIG. 13). This could be caused by the increase in stiffness caused by these additives.

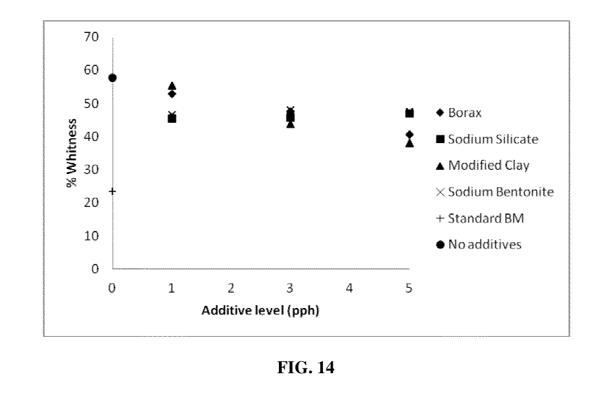

Whiteness levels decrease with the addition of clays and additives except sodium silicate which gave a 2% increase in whiteness (FIG. 14). The decrease in whiteness is caused by the incorporation of the clay or additives into the bioplastics matrix.

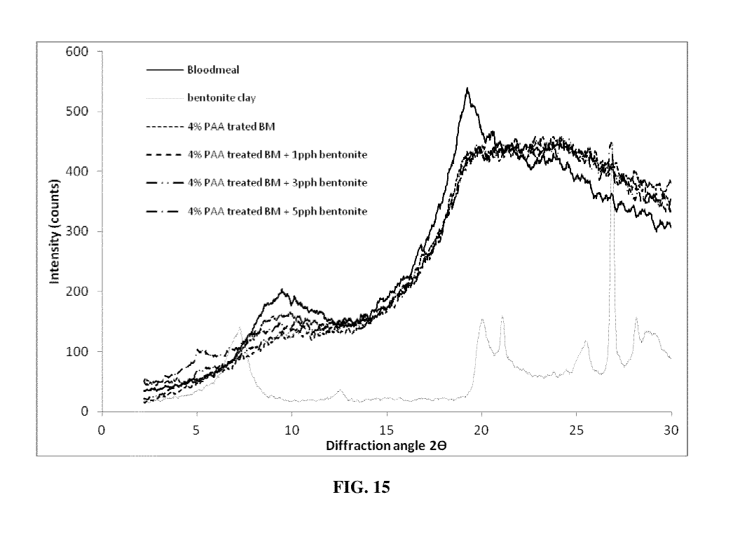

The graph shown in FIG. 15 includes diffraction patterns for 4% peracetic acid treated blood meal mixed with bentonite clay. In this graph, different concentrations of bentonite clay are compared along with a standard blood meal mixture. A left shift in the pure bentonite clay in the XRD spectra indicates an increase in basal spacing indicating intercalation of protein between the clay layers (FIG. 15). Clay increases the interactions as it bonds to the protein. The ordered structure provides the composite with a higher strength which is reflected in tensile strength graphs in comparison to 4% peracetic acid. At low levels of clay, the level of intercalation occurring is not enough to show up on the XRD graph. As the clay concentrations increase, the peak starts to become more distinct (as seen in the peak of 5 pph bentonite) showing an increase in basal spacing. Incorporation of bentonite also appears to affect the patterning between helices. As the levels of clay increase the patterning between alpha helices also increase. However, it did not seem to affect the patterning within the helical structure.

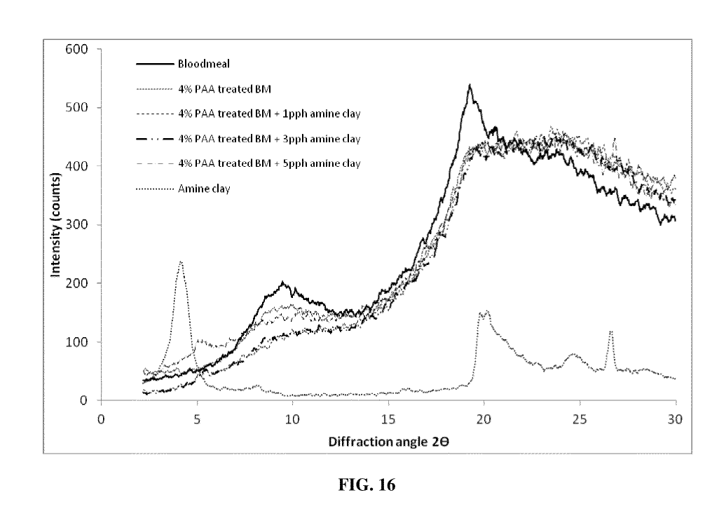

Amine modified clay is formed by inserting amine groups within bentonite clay layers. Adding amine groups causes an increase in basal spacing compared with standard bentonite clay, causing a XRD peak shift to left. Similarly to bentonite, intercalation occurs between the clay layers with an increase in concentrations of clay. This is seen by 5 pph modified amine clay having the highest peak. Unlike bentonite, the peak of 5 pph occurred to the right instead of left side of the pure clay peak. This suggests that the basal spacing has decreased. This indicates that the amine groups are getting replaced by the protein which is confirmed by comparing FIG. 15 and FIG. 16 where the peaks have shifted to the same location. Modified clay also shows an increase in inter helical patterning but does not affect the intra helical patterning.

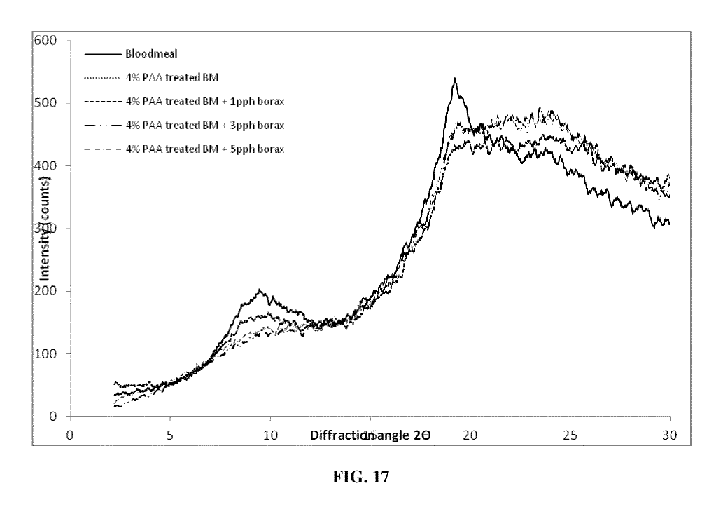

Borax causes a decrease in inter-helical patterning compared to other additives used (FIG. 17). This could explain the decrease in mechanical properties when borax is added (FIG. 10-13).

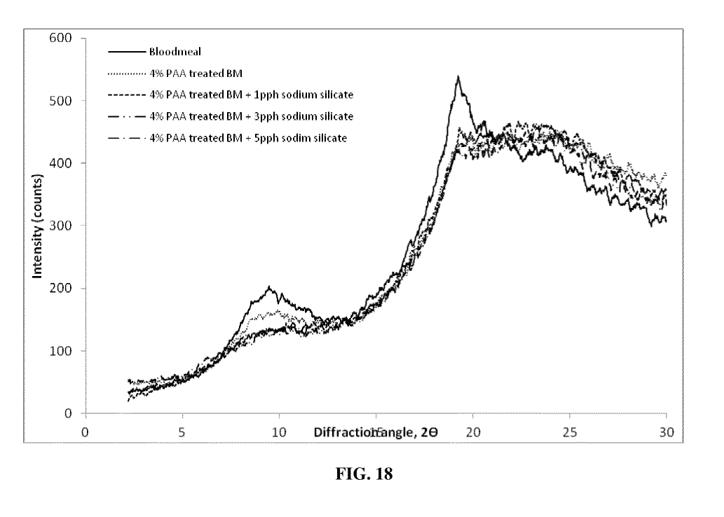

Adding sodium silicate does not increase the inter-helical patterning. This is the result of sodium silicate interacting with SDS. Both, sodium silicate and SDS repel each other as they contain a negative charge, causing a decrease in bonds and interactions. This could explain the decrease in mechanical properties when sodium silicate is added (FIG. 10-13 and FIG. 18).

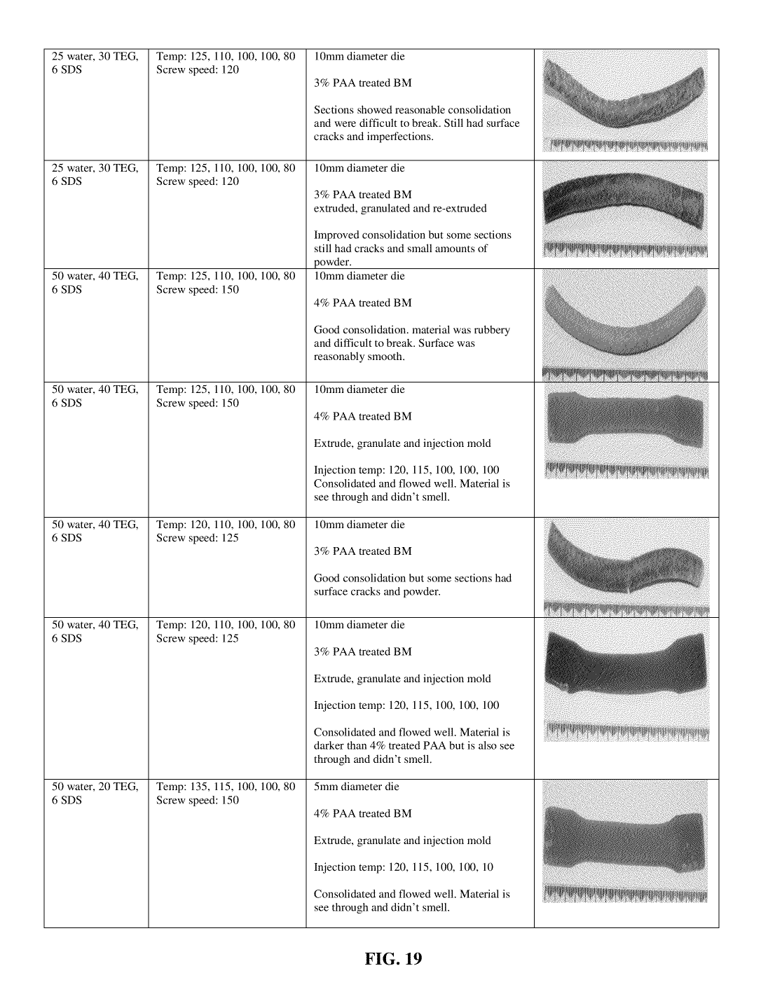

Additional data for extrusion and injection molding trials of decolorized blood meal are summarized in FIG. 19.

### Example 9

### Decolorization of Spray Dried Hemoglobin (SDH)

Peracetic solutions were prepared using a 5% stock solution. SDH (50 g) was combined with the appropriate amount of peracetic acid gradually and mixed in a blender at high speed for 10 to 12 minutes. The blended mixture was washed with 200 g distilled water by manually stirring the mixture for 5 minutes. The solids were separated from the liquid solution using a cheese cloth. The mixture was neutralized by adjusting the pH to 7 using 1 M NaOH after adding 150 g distilled water. The solids were separated from the solution using a cheese cloth. The solids were dried in a fan forced oven at 60° C. for 35 hours. The dried and decolored SDH was powdered using a micro grinder. At the initial mixing stage the SDH with peracetic acid becomes mushy and increases in volume. As mixing proceeds the volume shrinks and the speed of the mixer must be reduced. Addition of SDH into the peracetic acid solution resulted in complete mixing with a shorter mixing time (less than 15 min) compared to adding peracetic acid to SDH. The standard mixing time was 15 minutes. Processing of SDH and peracetic acid with different ratios of peracetic acid to SDH (1.5:1, 2.5:1, 3:1, and 4:1) and different peracetic acid concentrations (1-5% w/w) were performed.

At 3:1 peracetic acid to SDH ratio the following results were obtained:

PAA Concentration 0.5%. SDH and PAA did not mix well, remained a slurry and large amounts of foam was produced. Decolorization was not achieved, filtration was difficult, and the mixture could not be processed.

Concentration 1%. Hardly removed color from SDH and bit thicker than 0.5%. Washing caused some dissolution, so no further steps could be taken. The filtration was difficult, and the mixture could not be processed.

Concentration 2%. Effective mixing was achieved, decolored well, and a large amount of foam was produced during neutralizing that can only be removed with cheese cloth. The end product could be processed.

Concentration 3%. Effective mixing was achieved and decolored better than 2%, and did not produce significant amounts of foam during neutralizing and had minimal waste compared to 1 and 2% PAA. The end product was easy to filter and could be processed.

Concentration 4%. Became viscous and formed clumps resulting in ineffective mixing, but decolored well. Final product still had a strong acetic acid smell.

Concentration 5%. Highly decolored, but the end product was extremely sticky and became very rubbery making washing and filtration difficult. A very strong acetic acid odor remained in final product.

At 1.5:1 peracetic acid to SDH ratio the following results were obtained:

Concentration 1%. Mixed well and gave granular particles, but did not decolor at all. The end product was easy to filter.

Concentration 2%. Mixed well, but minimal decolorization took place. The end product was easy to filter.

Concentration 3%. Mixed well and decolored well. The end product was easy to filter.

Concentration 4%. Mixed well and decolored well, but the end product became sticky during mixing. The end product could not be processed.

Concentration 5%. The end product became very sticky after mixing. Decolorization optimal. The end product was difficult to wash and filter and could not be processed.

For all peracetic acid concentrations using a 1.5:1 peracetic acid to SDH ratio, blends became very hard and dry after mixing. It would be appear that SDH is able to absorb all the peracetic acid solution at this ratio making further processing very difficult.

At 4:1 and 5:1 peracetic acid to SDH ratio the following results were obtained:

Concentration 1%. Mixed well and gave granular particles, but did not decolor at all. Concentration 2%. The consistency was a bit thicker compared to using 1% peracetic acid, but the mixture was still frothy and dispersed in water. The end product could not be processed.

Concentration 3%. The consistency was even thicker, it could still be washed, but neutralizing resulted in the formation of thick slurry, and the end product could not be filtered.

Concentration 4% and 5%. Mixed well and decolored well, but the end product became sticky. At 5% PAA it became very hard and couldn't be filtered.

It was found that a ratio of 3:1 (peracetic acid:SDH), using a peracetic acid concentration of 3% was optimal in terms of ability of the end product to be processed, degree of decoloring, and that the parameters should be used in further processing and testing. With a ratio 2.5:1, SDH mixed, decolored well, and the end product can be processed. Ratio 3:1 worked well with peracetic acid concentrations of 2.5% and 3.5% and the difference in degree of decolorization can be visualized with the naked eye. It is also clear that decolored SDH becomes sticky with ratios exceeding 3:1, since 3.5:1 gave a sticky final product with a strong acidic odor. Samples were color analyzed and the results are summarized in Table 9.

In conclusion, the degree of decoloring increased with an increase in concentration and ratio of PAA:SDH. The consistency of the PAA/SDH mixture became thicker with an increase in PAA concentration and ratio of PAA:SDH. Using a PAA concentration of more than 3% made the SDH/PAA mixture sticky and mixing difficult. Ratios of 2.5:1 and 3:1 PAA:SDH are reliable methods at PAA concentration of 2.5% and 3% to effectively decolor and process SDH.

TABLE 9
Chromameter analysis of spray dried hemoglobin (SDH) decolored with peracetic acid
(PAA).

| | | Amount (Kg) | | | | | | | | |
|---|---|---|---|---|---|---|---|---|---|---|
| | | of 5% PAA | Cost of | | | | | | | |
| | Conc. | required for | PAA ($4 | | | | | | | |
| Ratio | PAA | 1 Kg of SDH | per Kg) | L | A | B | R | G | B | % Whiteness |
| 1.5:1 | 1% | 0.3 | 1.2 | 18 | 7 | 10 | 58 | 40 | 31 | 17% |
| 1.5:1 | 2% | 0.6 | 2.4 | 62 | 11 | 40 | 184 | 142 | 79 | 53% |
| 1.5:1 | 3% | 0.9 | 3.6 | 81 | 15 | 62 | 251 | 190 | 83 | 68% |
| 1.5:1 | 4% | 1.2 | 4.8 | 86 | 11 | 57 | 252 | 207 | 129 | 77% |
| 2.5:1 | 2.5% | 1.25 | 5 | 94 | 11 | 59 | 255 | 232 | 126 | 80% |
| 2.5:1 | 3% | 1.5 | 6 | 95 | 11 | 69 | 255 | 241 | 112 | 79% |
| 2.5:1 | 4% | 2 | 8 | 102 | 7 | 51 | 255 | 249 | 156 | 86% |
| 3.0:1 | 2% | 1.2 | 4.8 | 105 | 7 | 58 | 255 | 248 | 148 | 85% |
| 3.0:1 | 2.5% | 1.5 | 6 | 113 | 2 | 52 | 255 | 252 | 154 | 86% |
| 3.0:1 | 3% | 1.8 | 7.2 | 115 | −10 | 50 | 255 | 255 | 157 | 87% |
| 3.0:1 | 3.5% | 2.1 | 8.4 | 115 | −20 | 49 | 250 | 255 | 141 | 84% |
| 3.0:1 | 4% | 2.4 | 9.6 | 116 | −18 | 54 | 247 | 255 | 148 | 85% |
| 3.0:1 | 5% | 3 | 12 | 117 | −18 | 54 | 239 | 255 | 147 | 84% |
| 3.5:1 | 2.5% | 1.75 | 7 | 116 | −17 | 49 | 243 | 255 | 158 | 86% |
| 3.5:1 | 3% | 2.1 | 8.4 | 117 | −21 | 49 | 239 | 255 | 158 | 85% |
| 3.5:1 | 3.5% | 2.45 | 9.8 | 118 | −30 | 52 | 239 | 255 | 152 | 84% |

### Example 10

### Compression Molding of Decolored Spray Dried Hemoglobin (SDH)

Sodium dodecyl sulfate (SDS) and plasticizer were dissolved in distilled water and the solution was stirred at 60° C. for 5 minutes. SDH decolored with a PAA concentration of 5% was stirred into the SDS solution with a mixer for 5 to 6 minutes. The mixture was washed and filtered as in Example 9, and equilibrated for 10 to 12 hours before processing. The washed and filtered SDH sample (55 g) was placed between the upper and lower plates of the compression mold. The compression mold upper plate temperature was 165° C., and the upper mold reached 110° C. The lower plate temperature was 160° C., and the lower mold reached 110° C. A pressure of 10 tons compressed the decolored SDH. Higher pressures led to squeezing of the material out of the mold. Formulations with 20 ppH water, 3 or 6 ppH SDS, and 20 ppH triethylene glycol showed good consolidation and flowability.

SDH decolored with 2% PAA used for compression molding trials resulted in sheets that darkened during processing. SDH decolored with 4% PAA resulted in sheets that remained yellow and were more transparent compared to those made with 2% PAA SDH. When the amount of SDS and TEG were increased, the flowability increased significantly; however, optimal quality sheets could not be achieved as material is pressed out of the mold. Different types of plasticizers (other than TEG), such as triacetin, DEG, and ethylene glycol may help improve processing.

### Example 11

### Extrusion of Decolored Spray Dried Hemoglobin (SDH) with SDS and SS as Denaturing Agents

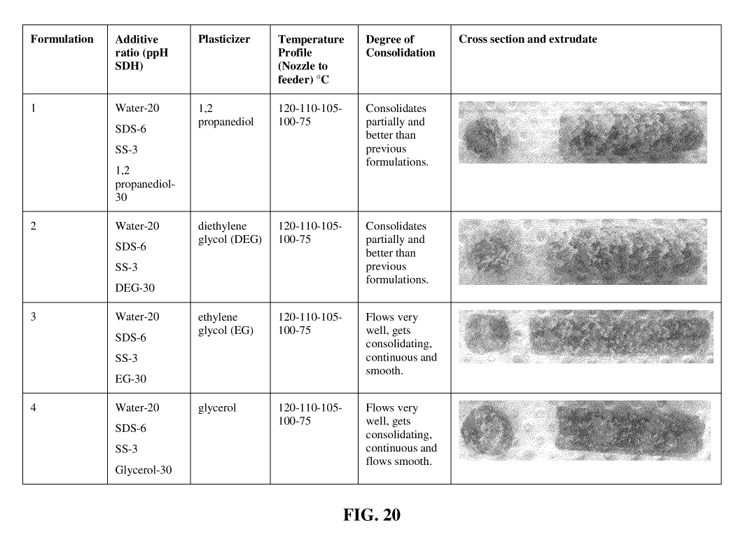

Water (20 ppH), SDS (6 ppH), SS (3 ppH), and plasticizer (30 ppH) were combined with 100 parts of SDH decolored with 3% peracetic acid to achieve reasonable extrusion. Ethylene glycol, diethylene glycol, triethylene glycol, polyethylene glycol, glycerol, triacetin, triethyl citrate, tributyl citrate, 1,2-propanediol, and epoxidized soy bean oil were used as plasticizers. SS does not improve consolidation. Ethylene glycol and glycerol consolidated the decolored spray dried hemoglobin with a smooth and continuous extrudate. The torque was kept between 8.4 and 9 Newton-meters, pressure ranged from 15-22 bar, the rpm was 150, the auger speed (screw feeder) was 8-9 Hz, and a pH of 7 was used for all formulations except indicated. A temperature of more than 125° C. darkens the material. No difference was observed when the pH was varied from 4, 7, and 10. 1,2-propanediol gave effective flowability during processing. The results are summarized in FIG. 20.

### Example 12

### Extrusion of Decolored Spray Dried Hemoglobin with SDS as a Denaturing Agent

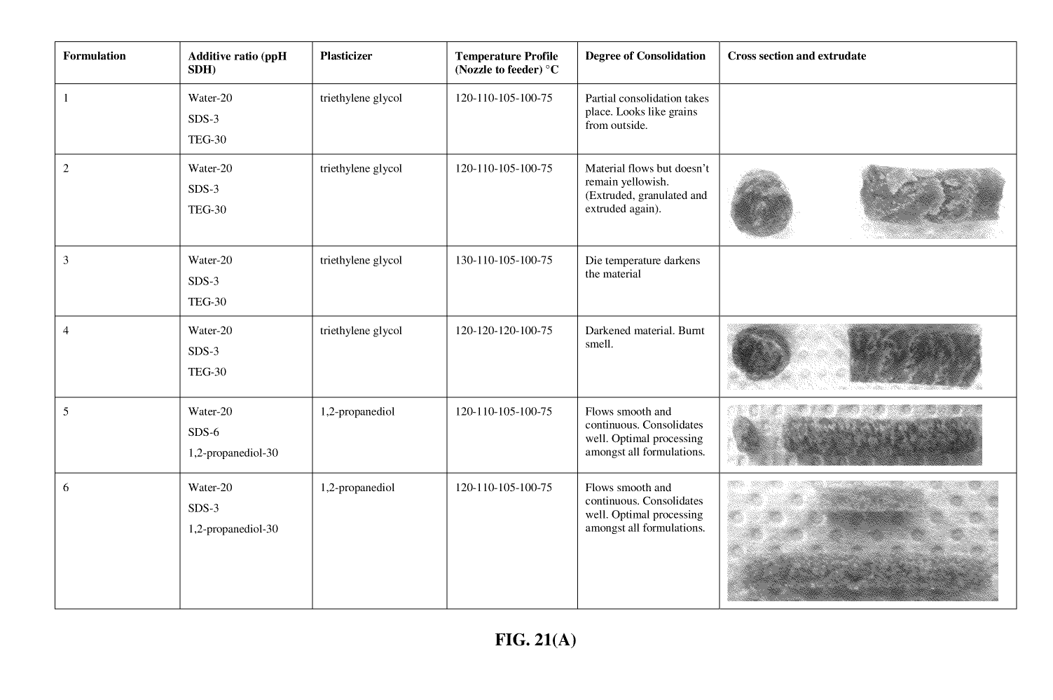

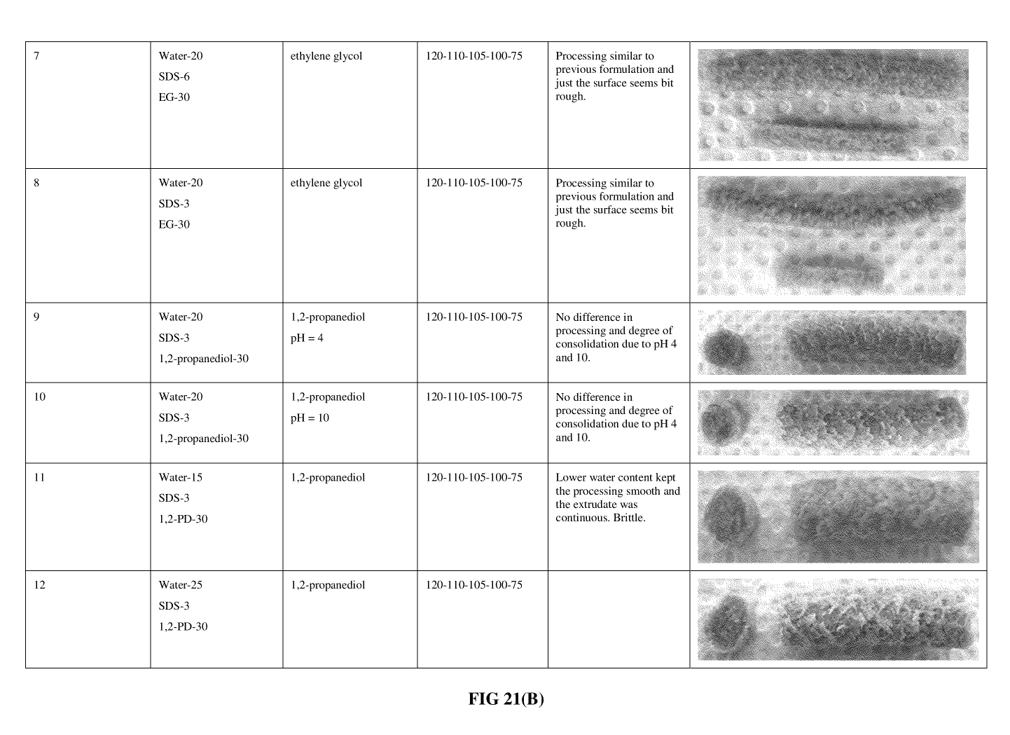

Water (15-40 ppH), SDS (3-6 ppH), and plasticizer (30 ppH) were combined with 100 parts of SDH decolored with 3% peracetic acid to achieve reasonable extrusion. Ethylene glycol, diethylene glycol, triethylene glycol, polyethylene glycol, glycerol, triacetin, triethyl citrate, tributyl citrate, 1,2-propanediol, and epoxidized soy bean oil were used as plasticizers. Ethylene glycol and glycerol consolidated the decolored spray dried hemoglobin with a smooth and continuous extrudate. The torque was kept between 8.4 and 9 Newton-meters, pressure ranged from 15-22 bar, the rpm was 250, the auger speed (screw feeder) was 8-9 Hz, and a pH of 7 was used for all formulations except indicated. A temperature of more than 125° C. darkens the material. No difference was observed when the pH was varied from 4, 7, and 10. 1,2-propanediol gave effective flowability during processing. The addition of SS did not make any improvement in consolidation. A high amount of water content (40 ppH) helped to avoid grainy surfaces on the extrudate. The lowest amount of water content tested (15 parts) made the extrudate very brittle. The results are summarized in FIG. 21.

### Example 13

### Compression Molding of Spray Dried Hemoglobin Extrudate Formulations

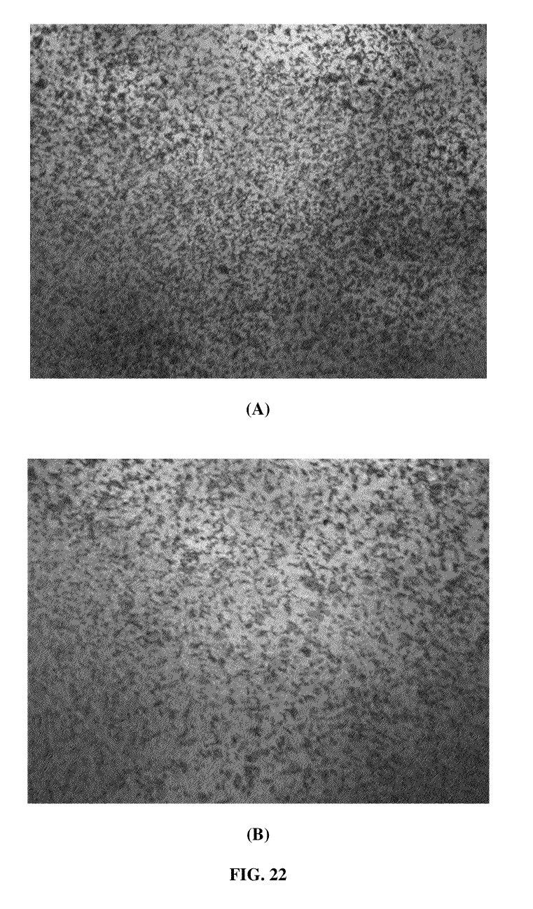

Compression molds with the most promising extrudate formulations 11 and 12 from Example 12 were performed. The compression mold upper plate temperature was 175° C., and the upper mold reached 120° C. The lower plate temperature was 170° C., and the lower mold reached 120° C. Formulation 11 with water (15 ppH), SDS (3 ppH), and 1,2 propanediol (30 ppH) and formulation 12 with water (25 ppH), SDS (3 ppH), and 1,2 propanediol (30 ppH) gave promising results as shown in FIG. 22.

### Example 14

### Injection Molding of Decolored Spray Dried Hemoglobin

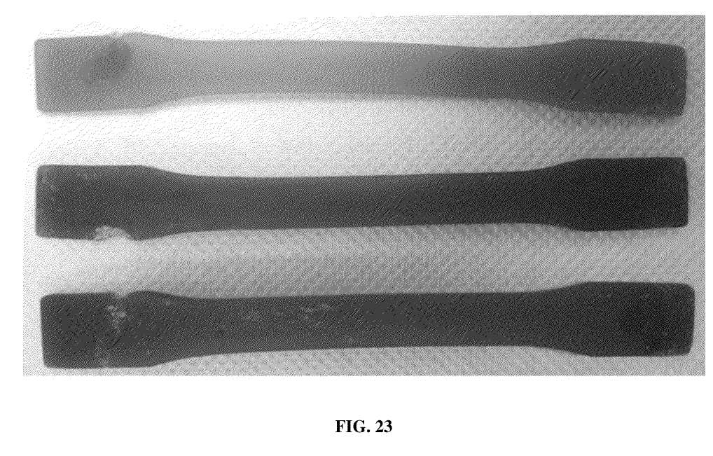

Formulation 12 with water (25 ppH), SDS (3 ppH), and 1,2 propanediol (30 ppH) was extruded and the extrudates were granulated and fed into the barrel of the injection molding machine. The material turned darker than its original color when fed into the injection barrel. When the material stayed more than five minutes in the barrel, the material turned darker. The material should not be in the barrel for more than 3 minutes. Colorant may be added before extrusion to get colored injection molded samples. Injection molded samples are shown in FIG. 23.

### Example 15

### Extrusion and Injection Molding of Decolored Blood Meal in the Absence of a Denaturing Agent

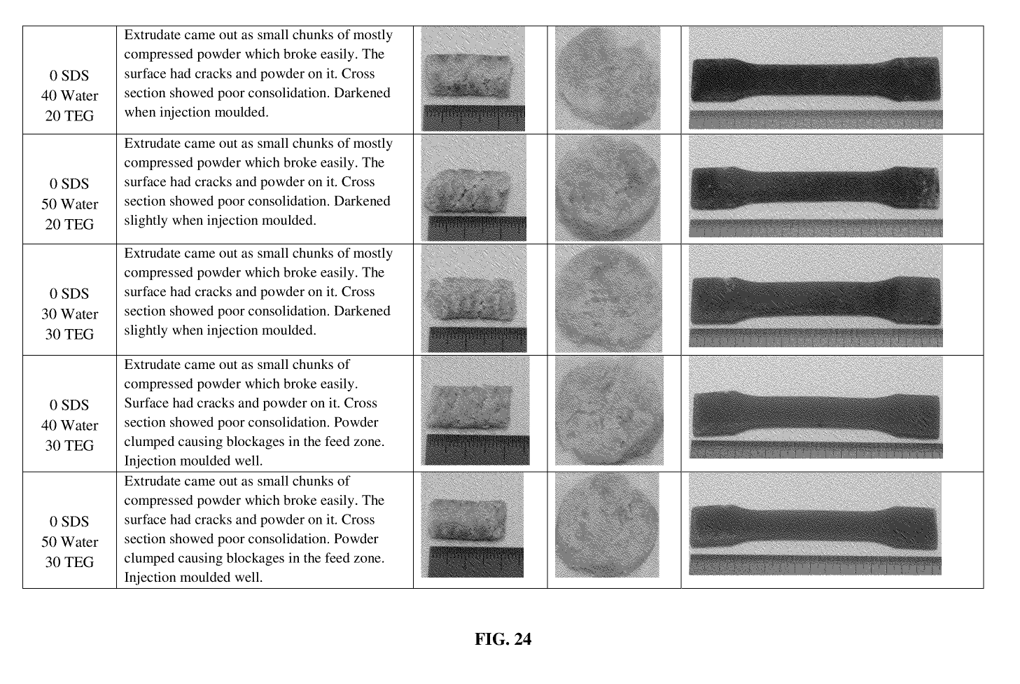

Water (30-50 ppH) and plasticizer (20-30 ppH) were combined with 100 parts decolored blood meal and extruded. The torque was kept between 8.4 and 9 Newton-meters, pressure ranged from 15-22 bar, the rpm was 150, the auger speed (screw feeder) was 8-9 Hz, and a pH of 7 was used for all formulations. The extrudates were granulated and fed into the barrel of the injection molding machine. The results are summarized in FIG. 24. This example demonstrates that decolored blood meal may be treated with a plasticizer to form a plastic material in the absence of added denaturing agent.

### Example 16

### Odor Results for Extrusions with Bloodmeal Treated with Oxidizing Agents

Extrusions with 3% peracetic acid treated bloodmeal resulted in the extrudate exiting the extruder as either a powder or small sections of compressed powder. When pre-extrusion mixtures where being produced a strong acetic acid smell was observed but the characteristic bloodmeal smell did not return.

Extrusions with peracetic acid treated bloodmeal where the acetic acid was not neutralized resulted in compressed powders and no melt formation (type one). A strong acetic acid smell was also observed during mixing and extrusion.

Initial extrusion trials using PAA, hydrogen peroxide and sodium chlorite treated bloodmeal were carried out using the standard formula (10 pph_{BM} urea, 3 pph_{BM} sodium sulphite, 3 pph_{BM} SDS, 60 pph_{BM} water, 10 pph_{BM} TEG) for processing untreated bloodmeal into Novatein Thermoplastic Protein (NTP). Hydrogen peroxide and sodium chlorite treated bloodmeal extrusions were unsuccessful and resulted in the extruder blocking, as well as the return of the bloodmeal smell.

What is claimed is:

1. A method of decolorizing blood protein and manufacturing the decolorized blood protein into a plastic material, the method comprising:
contacting the blood protein with an oxidizing agent to form a blood protein composition that includes unreacted oxidizing agent;
removing at least a portion of the unreacted oxidizing agent from the blood protein composition to form a decolorized blood protein composition; and
treating the decolorized blood protein composition in the presence of a plasticizer with sufficient pressure and temperature to form the plastic material.

2. The method of claim 1, further comprising contacting the decolorized blood protein composition with a denaturing agent prior to the treating step.

3. The method of claim 1, wherein the blood protein is selected from the group consisting of whole blood, isolated red blood cells, serum, hemoglobin, blood meal, spray dried hemoglobin, and mixtures thereof.

4. The method of claim 1, wherein the blood protein is blood meal or spray dried hemoglobin.

5. The method of claim 1, wherein the oxidizing agent is selected from the group consisting of peracetic acid, hydrogen peroxide, sodium chlorite, sodium hypochlorite, and combinations thereof.

6. The method of claim 5, wherein the oxidizing agent is peracetic acid.

7. The method of claim 6, wherein the peracetic acid is provided as an aqueous solution at a concentration of 1-5% peracetic acid by weight of the solution.

8. The method of claim 2, wherein the denaturing agent is sodium dodecyl sulfate (SDS), sodium sulfite, or a mixture thereof.

9. The method of claim 1, wherein the plasticizer is selected from the group consisting of ethylene glycol, diethylene glycol, triethylene glycol, polyethylene glycol, 1,2-propanediol, glycerol, and mixtures thereof.

10. The method of claim 1, wherein the plasticizer is present at a concentration of about 10-30% plasticizer by weight of the decolorized blood protein.

11. The method of claim 1, wherein the decolorized blood protein composition has a percent whiteness of 35-100%.

12. The method of claim 1, wherein the plastic material has a tensile strength of 1.5-6 MPa.

13. The method of claim 1, wherein the plastic material has a stress at break of 0.25-1.5 mPa.

14. The method of claim 1, wherein the plastic material has an elongation at break of 15-40 mm.

15. A plastic material, comprising:
(a) a blood protein residue having a percent whiteness of 35%-100%; and
(b) a plasticizer.

16. The plastic material of claim 15, further comprising a denaturing agent.

17. The plastic material of claim 16, wherein the denaturing agent is sodium dodecyl sulfate (SDS), sodium sulfite (SS), or a mixture thereof.

18. The plastic material of claim 15, wherein the plasticizer is selected from the group consisting of ethylene glycol, diethylene glycol, triethylene glycol, 1,2-propanediol, glycerol, and mixtures thereof.

19. The plastic material of claim 15, wherein the blood protein residue comprises a blood protein and an oxidizing agent.

20. The plastic material of claim 19, wherein the oxidizing agent is selected from the group consisting of peracetic acid, hydrogen peroxide, sodium chlorite, sodium hypochlorite, and combinations thereof.
